(19) United States
(12) Patent Application Publication
(10) Pub. No.: US 2026/0089738 A1
(43) Pub. Date: Mar. 26, 2026

(54) DOWNLINK CONTROL INFORMATION (DCI) RECEIVING METHOD AND APPARATUS, DCI SENDING METHOD AND APPARATUS, AND STORAGE MEDIUM

(71) Applicant: Beijing Xiaomi Mobile Software Co., Ltd., Beijing (CN)

(72) Inventor: Lei WANG, Beijing (CN)

(21) Appl. No.: 19/109,613

(22) PCT Filed: Sep. 9, 2022
(86) PCT No.: PCT/CN2022/118228

§ 371 Date: Mar. 7, 2025

(51) Int. Cl. H04W 72/232; H04W 72/1273

(52) U.S. Cl. CPC H04W 72/232; H04W 72/1273

(57) ABSTRACT

A downlink control information (DCI) receiving method is performed by a terminal and includes: determining multiple cells scheduled by multi-cell downlink control information (MC-DCI); determining a target size of the MC-DCI for the multiple cells; and receiving and parsing the MC-DCI in a scheduling cell based on the target size of the MC-DCI.

### CROSS-REFERENCE TO RELATED APPLICATIONS

The present disclosure is a U.S. national phase of PCT Application No. PCT/CN2022/118228 filed on Sep. 9, 2022, the content of which is hereby incorporated by reference in its entirety.

### TECHNICAL FIELD

The present disclosure relates to a field of communication, and in particular, to a downlink control information (DCI) receiving method and apparatus, a DCI sending method and apparatus, and storage mediums.

### BACKGROUND

A new radio (NR) technology in a 5-th generation mobile communication technology (5G) is applied in a relatively wide frequency spectrum range. With re-farming of a frequency domain or frequency band corresponding to an existing cellular network, utilization of a corresponding frequency spectrum will be steadily improved. Particularly, for a frequency range 1 (FR1), available frequency domain resources are gradually fragmented. In order to meet different frequency spectrum requirements, these scattered frequency spectrum resources need to be utilized with a higher frequency spectrum, a higher power efficiency, and a more flexible manner, thereby achieving higher network throughput and a good coverage range.

Based on a related mechanism, one piece of downlink control information (DCI) in an existing serving cell is only allowed to schedule data of one cell. With the gradual fragmentation of frequency resources, requirements for scheduling data of multiple cells at the same time will be gradually increased. Therefore, the DCI for scheduling the data of the multiple cells, i.e., multi-cell downlink control information (MC-DCI), needs to be introduced.

### SUMMARY

According to a first aspect of embodiments of the present disclosure, a DCI receiving method is provided. The method is performed by a terminal and includes: determining multiple cells scheduled by multi-cell downlink control information (MC-DCI); determining a target size of the MC-DCI for the multiple cells; and receiving and parsing the MC-DCI in a scheduling cell based on the target size of the MC-DCI.

According to a second aspect of embodiments of the present disclosure, a DCI sending method is provided. The method is performed by a base station and includes: determining multiple cells scheduled by multi-cell downlink control information (MC-DCI); determining a target size of the MC-DCI for the multiple cells; and sending the MC-DCI to a terminal in a scheduling cell based on the target size of the MC-DCI.

According to a third aspect of embodiments of the present disclosure, a computer readable storage medium is provided. The computer readable storage medium stores a computer program, and the computer program is configured to perform the above any one DCI receiving method.

According to a fourth aspect of embodiments of the present disclosure, a computer readable storage medium is provided. The computer readable storage medium stores a computer program, and the computer program is configured to perform the above any one DCI sending method.

According to a fifth aspect of embodiments of the present disclosure, a DCI receiving apparatus is provided. The apparatus includes: a processor; and a memory configured to store instructions executable by the processor; where the processor is configured to perform the above any one DCI receiving method.

According to a sixth eighth aspect of embodiments of the present disclosure, a DCI sending apparatus is provided. The apparatus includes: a processor; and a memory configured to store instructions executable by the processor; where the processor is configured to perform the above any one DCI sending method.

It should be understood that the above general description and the detailed description in the following text are only exemplary and explanatory, and cannot limit the present disclosure.

### BRIEF DESCRIPTION OF DRAWINGS

The accompanying drawings herein are incorporated into the specification and form a part of this specification, show embodiments conforming to the present disclosure and are used together with the specification to explain principles of the present disclosure.

FIG. 1A is a schematic flowchart of a DCI alignment mechanism shown according to an exemplary embodiment.

FIG. 1B is a schematic diagram of a scenario in which sizes of MC-DCI of different scheduled cells are different shown according to an exemplary embodiment.

FIG. 2 is a schematic flowchart of a DCI receiving method shown according to an exemplary embodiment.

FIG. 3 is a schematic flowchart of another DCI receiving method shown according to an exemplary embodiment.

FIG. 4 is a schematic flowchart of another DCI receiving method shown according to an exemplary embodiment.

FIG. 5 is a schematic flowchart of another DCI receiving method shown according to an exemplary embodiment.

FIG. 6 is a schematic flowchart of a DCI sending method shown according to an exemplary embodiment.

FIG. 7 is a schematic flowchart of another DCI sending method shown according to an exemplary embodiment.

FIG. 8 is a schematic flowchart of another DCI sending method shown according to an exemplary embodiment.

FIG. 9 is a schematic flowchart of another DCI sending method shown according to an exemplary embodiment.

FIG. 10A is a schematic diagram of a scenario of performing a DCI alignment shown according to an exemplary embodiment.

FIG. 10B is a schematic flowchart of another scenario of performing a DCI alignment shown according to an exemplary embodiment.

FIG. 11 is a block diagram of a DCI receiving apparatus shown according to an exemplary embodiment.

FIG. 12 is a block diagram of a DCI sending apparatus shown according to an exemplary embodiment.

FIG. 13 is a schematic structural diagram of a DCI receiving apparatus shown according to an exemplary embodiment of the present disclosure.

FIG. 14 is a schematic structural diagram of a DCI sending apparatus shown according to an exemplary embodiment of the present disclosure.

### DETAILED DESCRIPTION

Exemplary embodiments will be described in details herein, with examples thereof represented in the accompanying drawings. When the following description involves the accompanying drawings, same numerals in different figures represent same or similar elements unless otherwise indicated. Implementation manners described in the following exemplary embodiments do not represent all implementation manners consistent with the present disclosure. Rather, they are merely examples of apparatuses and methods consistent with some aspects of the present disclosure as detailed in the appended claims.

Terms used in the present disclosure are only for a purpose of describing specific embodiments, and are not intended to limit the present disclosure. Singular forms, “a/an,” “the,” and “this,” used in the present disclosure and the appended claims are also intended to include majority forms, unless the context clearly indicates other meanings. It should also be understood that the term “and/or” used herein refers to and includes any or all possible combinations of at least one related listed item.

It should be understood that although terms, such as “first,” “second,” “third,” etc., may be used in the present disclosure to describe various information, such information should not be limited by these terms. These terms are only used to distinguish a same type of information from each other. For example, without departing from the scope of the present disclosure, first information may also be referred to as second information, and similarly, the second information may also be referred to as the first information. Depending on the context, the term “if” used herein may be interpreted as “when,” “while,” or “in response to determining.”

In a carrier aggregation (CA) scenario, based on the related mechanism, to reduce a complexity of blind detection of a terminal, bit length types of DCI configured for a single scheduled cell are limited to not exceed 4 types, and bit length types of DCI scrambled by a cell-radio network temporary identifier (C-RNTI) configured for a cell do not exceed 3 types (a limitation condition of “3+1”). To meet the above limitations, DCI of different formats configured for a single scheduled cell may reduce, through a DCI alignment, the number of bit lengths of DCI monitored by a terminal in the cell, and the DCI alignment mainly implements consistency of sizes of DCI of same or different formats in a manner of zero-padding, truncating, etc.

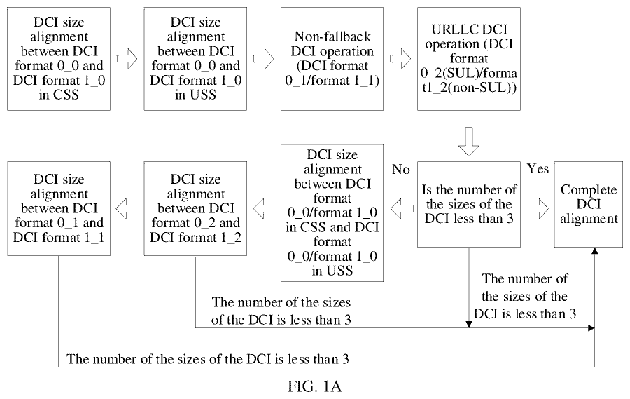

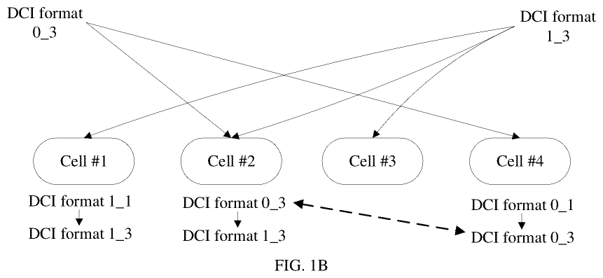

It should be noted that, in the present disclosure, the base station performs the DCI alignment, and the terminal side may deduce the DCI alignment performed by the base station side, to determine the size of the DCI, and receive the DCI based on the determined size. Specifically, the DCI alignment in the related mechanism may be, for example, as shown in FIG. 1A. The base station performs a DCI alignment between a DCI format 0_0 and a DCI format 1_0 in a common search space (CSS), and then performs the DCI alignment between the DCI format 0_0 and the DCI format 1_0 in a UE-specific search space (USS). Then, the base station performs a non-fallback DCI operation (for the DCI format 0_1/DCI format 1_1) and an ultra-reliable low-latency communication (URLLC) DCI operation (for the DCI format 0_2 (supplemental uplink, SUL)/format 0_2 (non-supplemental uplink, non-SUL)). Further, the base station determines whether the number of the sizes of the DCI is less than 3; when the number of the sizes of the DCI is less than 3, the base station determines that the DCI alignment is completed; otherwise, the base station performs the DCI alignment between the DCI format 0_0/format 1_0 in the USS and the DCI format 0_0/format 1_0 in the CSS; at this time, when the number of the sizes of the DCI is less than 3, the base station determines that the DCI alignment is completed; otherwise, the base station performs the DCI alignment between the DCI format 0_2 and the DCI format 1_2; similarly, at this time, when the number of the sizes of the DCI is less than 3, the base station determines that the DCI alignment is completed; otherwise, the base station continues to perform the DCI alignment between the DCI format 0_1 and the DCI format 1_1, so that the number of the sizes of the DCI is less than 3.

In a multi-cell scheduling scenario, there are two or more cells scheduled, and when the DCI alignment on DCI including MC-DCI is performed in each scheduled cell based on the related mechanism, the case in which sizes of the same MC-DCI are inconsistent may occur.

It should be noted that the MC-DCI includes, but is not limited to, a new DCI format 0_X in the present disclosure: for scheduling PUSCHs of multiple cells, which is described subsequently with the DCI format 0_3; a DCI format 1_X: for scheduling PDSCHs for multiple cells, which is described subsequently with the DCI format 1_3. It may be understood that the DCI format 0_3 and the DCI format 1_3 are merely exemplary description of formats of the MC-DCI. In the actual application, to distinguish the MC-DCI from the legacy DCI, the MC-DCI adopts the DCI format 0_X and the DCI format 1_X, where X has an integer value greater than or equal to 3, which should belong to the protection scope of the present disclosure. The legacy DCI includes but is not limited to a DCI format defined based on an existing protocol mechanism (Rel-15, Rel-16, or Rel-17), and the MC-DCI introduced for Rel-18 is not within a range of the legacy DCI.

In an example scenario as shown in FIG. 1B, in the scheduled cell #2, the size of the DCI format 0_3 is aligned with the size of the DCI format 1_3 through zero-padding, so that the size of the DCI format 0_3 is increased. However, in the scheduled cell #4, the size of the DCI format 0_3 is not increased.

That is, the same MC-DCI format 0_3 in different scheduled cells have different sizes. In this scenario, the terminal and the base station cannot determine the size of the MC-DCI actually transmitted, thereby damaging the transmission performance of the PDCCH.

In order to solve the above technical problem, the present disclosure provides a DCI receiving method and a DCI sending method, which may realize the alignment of the sizes of the same multi-cell downlink control information in different scheduled cells, reduce the complexity of the blind detection of the terminal, and improve the transmission performance of the PDCCH.

The DCI receiving method provided in the present disclosure is described from a terminal side first below.

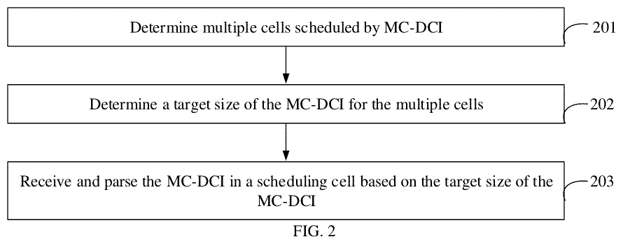

An embodiment of the present disclosure provides a DCI receiving method. Referring to FIG. 2, FIG. 2 is a flowchart of a DCI receiving method shown according to an embodiment. The method may be performed by a terminal. The method may include the following steps 201-203.

At step 201, multiple cells scheduled by multi-cell downlink control information (MC-DCI) are determined.

In an embodiment of the present disclosure, the MC-DCI is used to schedule data transmission of multiple cells. The data transmission of each cell corresponds to one physical downlink shared channel (PDSCH) and/or one physical uplink shared channel (PUSCH).

In the embodiment of the present disclosure, the multiple cells scheduled by the same MC-DCI may refer to one or more scheduled cells scheduled by the MC-DCI at the same moment, for example, the multiple cells {cell #1, cell #2, cell #3} scheduled by the MC-DCI (the format of the MC-DCI may be format 0_3 or format 1_3) at the moment t1.

The multiple cells scheduled by the same MC-DCI may also refer to a set of all cells scheduled by the same MC-DCI at different moments from a static or semi-static perspective. For example, the MC-DCI with the format 0_3 supports dynamic handover of scheduled cells, the cells scheduled by the MC-DCI at the moment t1 are {cell #1, cell #2, cell #3} , the cells scheduled by the MC-DCI at the moment t2 are {cell #3, cell #4} , and then the multiple cells scheduled by the same MC-DCI are {cell #1, cell #2, cell #3, cell #4} in the present disclosure.

The multiple cells scheduled by the same MC-DCI may also refer to a set of all cells that may be scheduled by the MC-DCI. For example, when a set of cells that may be scheduled by certain MC-DCI is {cell #1, cell #2, cell #4}, and the MC-DCI may schedule one or more cells in the set of cells, the multiple cells scheduled by the same MC-DCI may refer to all cells included in the set of cells.

At step 202, a target size of the MC-DCI for the multiple cells is determined.

In the embodiment of the present disclosure, the terminal may deduce the DCI alignment performed by the base station side, so that in a case where the number of sizes of DCI configured for each of the multiple cells meets a preset limitation condition, a uniform target size of the MC-DCI for the multiple cells is determined. The specific implementation manner is described in the subsequent embodiment, and is not described temporarily herein.

In the embodiment of the present disclosure, the preset limitation condition may be a limitation condition of “3+1” in a related mechanism, a limitation condition of “4+1”, or another preset limitation condition that needs to be met by the number of sizes of DCI configured for each serving cell, which is not limited in the present disclosure. The limitation condition of “4+1” means that the number of size types of DCI scrambled by C-RNTI in the serving cell does not exceed 4, and the total number of size types of DCI configured for the serving cell does not exceed 5.

At step 203, the MC-DCI is received and parsed in a scheduling cell based on the target size of the MC-DCI.

It should be noted that the cell scheduled by the MC-DCI is also referred to as a scheduled cell, and the multiple cells scheduled by the MC-DCI in the embodiment of the present disclosure refer to multiple scheduled cells.

In the embodiment of the present disclosure, a scheduling cell refers to a cell in which a terminal actually detects and receives MC-DCI. The scheduling cell may be any one of the multiple cells (i.e., the multiple scheduled cells), or the scheduling cell may be a cell different from the multiple cells (i.e., the multiple scheduled cells), which is not limited in the present disclosure. The terminal may receive and parse the MC-DCI in the scheduling cell based on the target size of the MC-DCI determined in the step 202.

For example, the MC-DCI schedules the cell #1 and the cell #2, and thus the multiple (scheduled) cells refer to the cell #1 and the cell #2. However, the scheduling cell may be one of the multiple (scheduled) cells, for example, the scheduling cell may be the cell #1 or the cell #2, and the terminal may receive and parse the MC-DCI in the cell #1 or the cell #2.

For another example, the MC-DCI schedules the cell #1 and the cell #2, and thus the multiple (scheduled) cells refer to the cell #1 and the cell #2. However, the scheduling cell may be a cell different from the multiple (scheduled) cells, for example, the scheduling cell may be the cell #3, and the terminal may receive and parse the MC-DCI in the cell #3.

In the above embodiment, the alignment of the sizes of the same multi-cell downlink control information in different scheduled cells may be realized, the complexity of the blind detection of the terminal may be reduced, and the transmission performance of the PDCCH may be improved.

An implementation manner of determining the target size of the MC-DCI for the multiple cells is specifically described below.

In a first method, the terminal deduces a DCI alignment in at least one scheduled cell in the multiple cells, and finally determines a target size of the MC-DCI, in the case where the number of sizes of DCI configured for each scheduled cell meets the preset limitation condition in combination with the DCI alignment deduced across the scheduled cells.

An embodiment of the present disclosure provides a DCI receiving method. Referring to FIG. 3, FIG. 3 is a flowchart of a DCI receiving method shown according to an embodiment. The method may be performed by a terminal. The method may include the following steps 301-304.

At step 301, multiple cells scheduled by MC-DCI are determined.

In the embodiment of the present disclosure, the MC-DCI is used to schedule data transmission of the multiple cells. The data transmission of each cell corresponds to one PDSCH and/or one PUSCH.

In the embodiment of the present disclosure, the multiple cells scheduled by the same MC-DCI may refer to one or more scheduled cells scheduled by the MC-DCI at the same moment, for example, the multiple cells {cell #1, cell #2, cell #3} scheduled by the MC-DCI (the format of the MC-DCI may be format 0_3 or format 1_3) at the moment t1.

The multiple cells scheduled by the same MC-DCI may also refer to a set of all cells scheduled by the same MC-DCI at different moments from a static or semi-static perspective. For example, the MC-DCI with the format 0_3 supports dynamic handover of scheduled cells, the cells scheduled by the MC-DCI at the moment t1 are {cell #1, cell #2, cell #3}, the cells scheduled by the MC-DCI at the moment t2 are {cell #3, cell #4} , and then the multiple cells scheduled by the same MC-DCI are {cell #1, cell #2, cell #3, cell #4} in the present disclosure.

The multiple cells scheduled by the same MC-DCI may also refer to a set of all cells that may be scheduled by the MC-DCI. For example, when a set of cells that may be scheduled by certain MC-DCI is {cell #1, cell #2, cell #4}, and the MC-DCI may schedule one or more cells in the set of cells, the multiple cells scheduled by the same MC-DCI may refer to all cells included in the set of cells.

At step 302, first sizes of the MC-DCI are determined for at least one cell in the multiple cells.

In an embodiment of the present disclosure, in the case where the number of sizes of DCI configured for each cell meets a preset limitation condition based on a DCI alignment performed on DCI including the MC-DCI for the at least one cell in the multiple cells, the first sizes of the MC-DCI for the at least one cell are determined.

In the related technology, the DCI alignment is performed by the base station, and the base station performs the DCI alignment according to each (scheduled) cell (or, per cell), including but not limited to performing the DCI alignment based on a time-frequency resource of the cell, and may also include performing the DCI alignment on the number of formats of DCI and the number of sizes of DCI configured for the entire cell in a zero-padding manner or in another manner, for example, a truncating manner.

For example, after the base station determines that DCI with a certain format after alignment needs to occupy n1 bits, and the size of the DCI determined by the base station is n2 bits, where n2 is less than n1. At this time, the base station may increase the size of the DCI to n1 by padding zero bits. For another example, after the base station determines that DCI with a certain format after alignment needs to occupy n1 bits, and the size of the DCI determined by the base station is n2 bits, where n2 is greater than n1. At this time, the base station may reduce the number of bits in the DCI to n1 in a truncating manner.

The terminal may receive radio resource control (RRC) signalling sent by the base station, to determine information such as a format of DCI and a size of DCI that the terminal may need to perform blind detection, and the terminal deduces the DCI alignment based on the information such as the format of DCI and the size of DCI that the terminal may need to perform the blind detection, to determine an actual size of the DCI, to receive and parse the DCI.

In the related technology, the limitation on the size of DCI needs to meet the limitation condition of “3+1”. The limitation condition of “3+1” means that the number of size types of DCI scrambled by C-RNTI in the serving cell does not exceed 3, and the total number of size types of DCI configured for the serving cell does not exceed 4.

However, in the embodiment of the present disclosure, the preset limitation condition may be a limitation condition of “3+1” in a related mechanism, a limitation condition of “4+1”,or another preset limitation condition that needs to be met by the number of sizes of DCI configured for each serving cell, which is not limited in the present disclosure. The limitation condition of “4+1” means that the number of size types of DCI scrambled by C-RNTI in the serving cell does not exceed 4, and the total number of size types of DCI configured for the serving cell does not exceed 5.

In the embodiment of the present disclosure, for the base station side, the cell in which the DCI alignment on DCI including the MC-DCI is performed may be each of the multiple cells, or may be a part of the multiple cells, or may be one of the multiple cells, which is not limited in the present disclosure.

Correspondingly, in a possible implementation manner, the terminal may deduce, in each of the multiple cells, the DCI alignment on the DCI including the MC-DCI that is performed by the base station, and determine the first size of the MC-DCI in each cell in the case where the number of sizes of DCI configured for each cell meets a preset limitation condition.

In another possible implementation manner, the terminal may deduce, in one or more specific cells of the multiple cells, the DCI alignment on the DCI including the MC-DCI that is performed by the base station, and finally determine the first sizes of the MC-DCI in the one or more specific cells in the case where it is ensured that the number of sizes of DCI configured for each of the multiple cells meets a preset limitation condition.

The one or more specific cells may be one or more cells in which the number of sizes of DCI configured, by the terminal, in the multiple cells does not meet the preset limitation condition.

In a possible implementation manner, the DCI alignment on the DCI including the MC-DCI may include but is not limited to any one of: a DCI alignment performed on MC-DCI of different formats; a DCI alignment performed on MC-DCI of different formats, and then a further DCI alignment performed on aligned MC-DCI with legacy DCI of at least one format; or a DCI alignment performed on legacy DCI of different formats, and then a further DCI alignment performed on aligned legacy DCI with MC-DCI of at least one format.

The MC-DCI includes, but is not limited to, a new DCI format 0_3: for scheduling PUSCHs for multiple cells; DCI format 1_3: for scheduling PDSCHs of multiple cells; correspondingly, a DCI alignment performed on MC-DCI of different formats may refer to size alignment between the DCI format 0_3 and the DCI format 1_3.

A DCI alignment performed on MC-DCI of different formats, and then a further DCI alignment performed on aligned MC-DCI with legacy DCI of at least one format may mean: performing size alignment between the DCI format 0_3 and the DCI format 1_3, and then performing the size alignment with legacy DCI of at least one format. In the embodiment of the present disclosure, the legacy DCI refers to a DCI format defined based on an existing protocol mechanism (Rel-15, Rel-16, or Rel-17), and the MC-DCI introduced for Rel-18 is not within a range of the legacy DCI.

For example, a DCI alignment performed on MC-DCI of different formats, and then a further DCI alignment performed on aligned MC-DCI with legacy DCI of at least one format may mean: performing size alignment between the DCI format 0_3 and the DCI format 1_3, and then performing the size alignment with the legacy DCI, for example, the DCI format 0_1 and/or the DCI format 1_1.

For another example, a DCI alignment performed on MC-DCI of different formats, and then a further DCI alignment performed on aligned MC-DCI with legacy DCI of at least one format may mean: performing size alignment between the DCI format 0_3 and the DCI format 1_3, and then performing the size alignment with the legacy DCI, for example, the DCI format 0_2 and/or the DCI format 1_2.

A DCI alignment performed on legacy DCI of different formats, and then a further DCI alignment performed on aligned legacy DCI with MC-DCI of at least one format may mean: performing size alignment on legacy DCI of different formats according to a related mechanism, including but not limited to the size alignment between the DCI format 0_1 and the DCI format 1_1, and/or the size alignment between the DCI format 0_2 and the DCI format 1_2, etc., and further performing the size alignment with the DCI format 0_3 and/or the DCI format 1_3.

At step 303, the target size of the MC-DCI for the multiple cells is determined based on the determined first sizes of the MC-DCI for the at least one cell.

In the embodiment of the present disclosure, the number of the first sizes is equal to the number of cells in which the terminal deduces the DCI alignment performed by the base station. Correspondingly, when there are multiple and different first sizes determined by the MC-DCI in at least one of the multiple cells, the terminal may determine a maximum value of the determined first sizes of the MC-DCI for the at least one cell as the target size of the MC-DCI.

At step 304, the MC-DCI is received and parsed in a scheduling cell based on the target size of the MC-DCI.

In this embodiment of the present disclosure, after the terminal determines the target size of the MC-DCI, the terminal needs to re-deduce, in at least one of the multiple cells, the DCI alignment on DCI including the MC-DCI performed by the base station, so that the number of formats of the DCI configured for each cell meets the preset limitation condition, to determine the size of the DCI configured for each cell. The specific deducing manner is similar to deducing the DCI alignment on DCI including the MC-DCI performed by the base station for the at least one cell in the above step 302, and will be not repeated herein.

The cell in which the DCI alignment on DCI including the MC-DCI is performed may be each of the multiple cells, or may be a part of the multiple cells, or may be one of the multiple cells, which is not limited in the present disclosure.

In the embodiment of the present disclosure, when there is a cell configured with legacy DCI in the multiple cells, the size of the legacy DCI is generally smaller than the size of the MC-DCI, that is, the legacy DCI needs to be aligned to the size of the MC-DCI, therefore, after the DCI alignment is re-deduced for at least one cell in the multiple cells, the determined size of the MC-DCI is still the target size. The terminal may receive and parse the MC-DCI in the scheduling cell based on the target size of the MC-DCI.

In the embodiment of the present disclosure, the scheduling cell refers to a cell in which the terminal actually detects and receives the MC-DCI, and the scheduling cell may be any one of multiple cells scheduled by the MC-DCI, or the scheduling cell may be a cell different from the multiple cells, which is not limited in the present disclosure.

In the above embodiment, a DCI alignment mechanism between multiple cells scheduled by a same MC-DCI is added, such that the alignment of the sizes of the same multi-cell downlink control information in different scheduled cells is realized, the complexity of the blind detection of the terminal is reduced, and the transmission performance of the PDCCH is improved.

In a second method, for one or more specific cells of the multiple cells scheduled by the MC-DCI, the number of MC-DCI is limited.

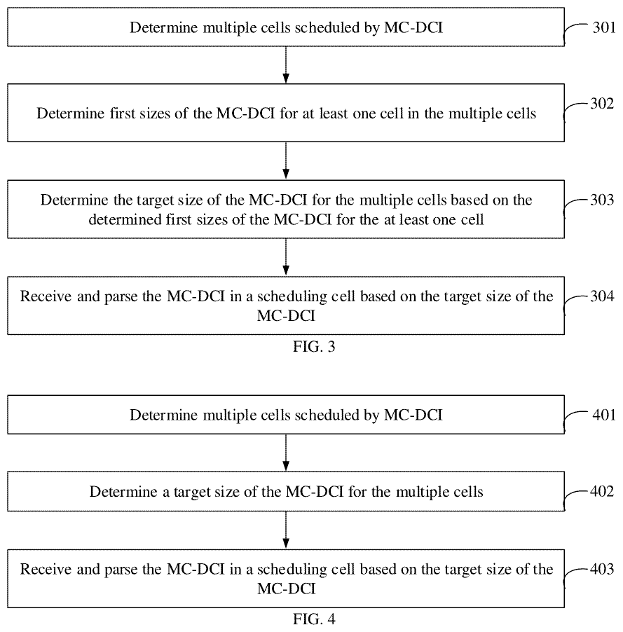

An embodiment of the present disclosure provides a DCI receiving method. Referring to FIG. 4, FIG. 4 is a flowchart of a DCI receiving method shown according to an embodiment. The method may be performed by a terminal. The method may include the following steps 401-403.

At step 401, multiple cells scheduled by MC-DCI are determined.

In the embodiment of the present disclosure, the MC-DCI is used to schedule data transmission of the multiple cells. The data transmission of each cell corresponds to one PDSCH and/or one PUSCH.

In the embodiment of the present disclosure, the multiple cells scheduled by the same MC-DCI may refer to one or more scheduled cells scheduled by the MC-DCI at the same moment, for example, the multiple cells {cell #1, cell #2, cell #3} scheduled by the MC-DCI (the format of the MC-DCI may be format 0_3 or format 1_3) at the moment t1.

The multiple cells scheduled by the same MC-DCI may also refer to a set of all cells scheduled by the same MC-DCI at different moments from a static or semi-static perspective. For example, the MC-DCI with the format 0_3 supports dynamic handover of scheduled cells, the cells scheduled by the MC-DCI at the moment t1 are {cell #1, cell #2, cell #3} , the cells scheduled by the MC-DCI at the moment t2 are {cell #3, cell #4} , and then the multiple cells scheduled by the same MC-DCI are {cell #1, cell #2, cell #3, cell #4} in the present disclosure.

The multiple cells scheduled by the same MC-DCI may also refer to a set of all cells that may be scheduled by the MC-DCI. For example, when a set of cells that may be scheduled by certain MC-DCI is {cell #1, cell #2, cell #4}, and the MC-DCI may schedule one or more cells in the set of cells, the multiple cells scheduled by the same MC-DCI may refer to all cells included in the set of cells.

At step 402, a target size of the MC-DCI for the multiple cells is determined.

In a related mechanism, the DCI alignment is performed respectively in each of the multiple cells (referring to FIG. 1A), and after the MC-DCI is introduced, there may be a case that the same MC-DCI corresponds to different sizes after performing the DCI alignment in different scheduled cells.

In view of the above problem, it is considered that in most scenarios, the sizes of MC-DCI are larger than the size of the legacy DCI in the present disclosure. The problem of inconsistent sizes of the MC-DCI mainly comes from the alignment between the DCI format 0_3 and the DCI format 1_3. Based on this, in the embodiment of the present disclosure, the number of pieces of the MC-DCI is mainly limited for one or more specific cells in multiple cells scheduled by the MC-DCI, to avoid occurrence of the alignment between the DCI format 0_3 and the DCI format 1_3 from a perspective of limiting MC-DCI scheduling.

In a possible implementation manner, the terminal does not expect that the number of formats of the MC-DCI configured for any one cell is greater than 1. That is, the terminal does not expect to configure MC-DCI of more than one format in any one of the multiple cells scheduled by the same MC-DCI.

For example, cells scheduled by the DCI format 0_3 include the cell #1 and the cell #3, and the cell #1 or the cell #3 is not scheduled by the DCI format 1_3.

In another possible implementation manner, the terminal does not expect that a preset limitation condition is met through performing a DCI alignment between MC-DCI of different formats in any one cell. That is, the terminal does not expect that the preset limitation condition is met through performing the DCI alignment between the DCI format 0_3 and the DCI format 1_3 in any one of the multiple cells scheduled by the same MC-DCI.

In the embodiment of the present disclosure, the preset limitation condition may be a limitation condition of “3+1” in a related mechanism, a limitation condition of “4+1”, or another preset limitation condition that needs to be met by the number of sizes of DCI configured for each serving cell, which is not limited in the present disclosure.

In another possible implementation manner, in a case where one or more pieces of MC-DCI are configured for any one cell, the terminal does not expect that sizes of the MC-DCI are changed in an alignment manner.

That is, when one or more pieces of MC-DCI are configured for any one of multiple cells scheduled by the same MC-DCI, the terminal does not expect that a size of any MC-DCI configured for the cell is changed in an alignment manner, such as zero-padding or truncating.

In the present disclosure, for one or more specific cells of the multiple cells scheduled by the MC-DCI, the number of the MC-DCI is limited, so that the terminal determines the target size of the MC-DCI in at least one of the multiple cells by deducing the DCI alignment performed by the base station side according to the related mechanism. In addition, the terminal finally determines the same target size of the MC-DCI in the multiple cells. An implementation manner of deducing the DCI alignment performed by the base station side according to the related mechanism is similar to that shown in FIG. 1A, and a difference lies in that MC-DCI is introduced, and for any one cell, there is no alignment between MC-DCI of different formats, and a specific process is not repeated herein.

It should be noted that, because the sizes of the MC-DCI corresponding to any one of the multiple cells are not changed in an alignment manner such as zero-padding or truncating, the terminal finally determines the same target size of the MC-DCI in the multiple cells.

At step 403, the MC-DCI is received and parsed in a scheduling cell based on the target size of the MC-DCI.

In the embodiment of the present disclosure, the scheduling cell refers to a cell in which the terminal actually detects and receives the MC-DCI, and the scheduling cell may be any one of multiple cells scheduled by the MC-DCI, or the scheduling cell may be a cell different from the multiple cells, which is not limited in the present disclosure.

In the above embodiment, the size of the MC-DCI may be prevented from being changed in an alignment manner, in the scenario in which the MC-DCI is introduced, the DCI alignment is simplified, the alignment of the sizes of the same multi-cell downlink control information in different scheduled cells is realized, the complexity of the blind detection of the terminal is reduced, and the transmission performance of the PDCCH is improved.

In third method, before deducing the DCI alignment performed by the base station in at least one of the multiple cells scheduled by the same MC-DCI, the terminal predetermines that the DCI alignment is performed on different MC-DCI in a zero-padding manner.

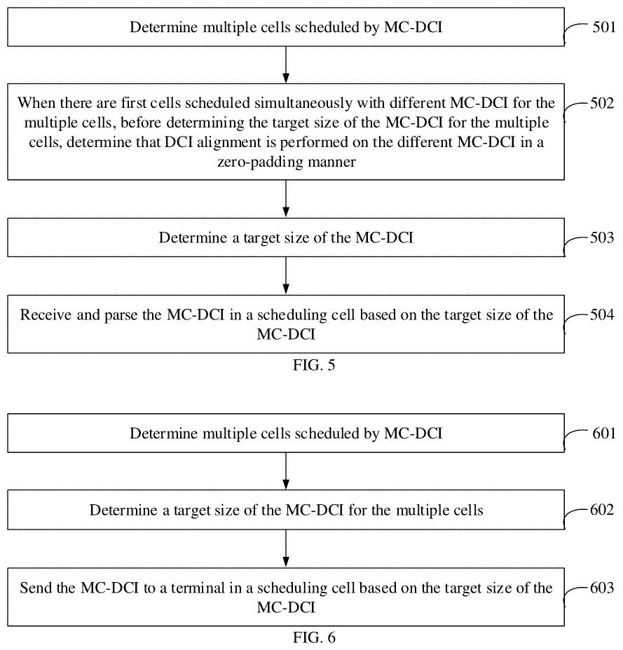

An embodiment of the present disclosure provides a DCI receiving method. Referring to FIG. 5, FIG. 5 is a flowchart of a DCI receiving method shown according to an embodiment. The method may be performed by a terminal. The method may include the following steps 501-504.

At step 501, multiple cells scheduled by MC-DCI are determined.

In the embodiment of the present disclosure, the MC-DCI is used to schedule data transmission of the multiple cells. The data transmission of each cell corresponds to one PDSCH and/or one PUSCH.

In the embodiment of the present disclosure, the multiple cells scheduled by the same MC-DCI may refer to one or more scheduled cells scheduled by the MC-DCI at the same moment, for example, the multiple cells {cell #1, cell #2, cell #3} scheduled by the MC-DCI (the format of the MC-DCI may be format 0_3 or format 1_3) at the moment t1.

The multiple cells scheduled by the same MC-DCI may also refer to a set of all cells scheduled by the same MC-DCI at different moments from a static or semi-static perspective. For example, the MC-DCI with the format 0_3 supports dynamic handover of scheduled cells, the cells scheduled by the MC-DCI at the moment t1 are {cell #1, cell #2, cell #3} , the cells scheduled by the MC-DCI at the moment t2 are {cell #3, cell #4} , and then the multiple cells scheduled by the same MC-DCI are {cell #1, cell #2, cell #3, cell #4} in the present disclosure.

The multiple cells scheduled by the same MC-DCI may also refer to a set of all cells that may be scheduled by the MC-DCI. For example, when a set of cells that may be scheduled by certain MC-DCI is {cell #1, cell #2, cell #4}, and the MC-DCI may schedule one or more cells in the set of cells, the multiple cells scheduled by the same MC-DCI may refer to all cells included in the set of cells.

At step 502, when there are first cells scheduled simultaneously with different MC-DCI for the multiple cells, before determining the target size of the MC-DCI for the multiple cells, it is determined that a DCI alignment is performed on the different MC-DCI in a zero-padding manner.

In the embodiment of the present disclosure, different MC-DCI may refer to MC-DCI of different formats, for example, the DCI format 0_3 and the DCI format 1_3 involved in the present disclosure.

Alternatively, different MC-DCI may refer to MC-DCI that schedules different sets of cells in a same format. It should be noted that each set of cells includes at least one cell, and any two sets of cells do not include a same cell.

For example, when both two pieces of MC-DCI have the format 0_3, MC-DCI #1 schedules the cell #1 and the cell #2, and MC-DCI #2 schedules the cell #3 and the cell #4, the MC-DCI #1 and the MC-DCI #2 are different MC-DCI.

In the embodiment of the present disclosure, before the terminal deduces the DCI alignment performed by the base station in at least one of the multiple cells according to the related mechanism and determines the target size of the MC-DCI in the multiple cells, the terminal may predetermine that the DCI alignment is performed on the different MC-DCI in the zero-padding manner, that is, the MC-DCI with a small size is aligned to the MC-DCI with a large size in the zero-padding manner. Deducing the DCI alignment performed by the base station according to the related mechanism is similar to that shown in FIG. 1A, and a difference lies in that before deducing legacy DCI alignment performed by the base station, it is determined that the base station performs the MC-DCI alignment in advance. The specific process is not repeated herein.

At step 503, a target size of the MC-DCI is determined.

In the above first method, the terminal first deduces a DCI alignment on DCI including MC-DCI that is performed by the base station in at least one of the multiple cells, and after determining first sizes of the corresponding MC-DCI, deduces the MC-DCI alignment performed by the base station between scheduled cells (that is, the DCI alignment is performed on the MC-DCI with the first sizes to the MC-DCI with the target size in a zero-padding manner), and then re-deduces the DCI alignment on DCI including MC-DCI that is performed by the base station in at least one of the multiple cells, and finally determines the size of the MC-DCI as the target size.

However, in the third method, when the first cell exists, the terminal first deduces a DCI alignment performed by the base station between different MC-DCI, and then deduces a DCI alignment performed by the base station in at least one of the multiple cells, so that the number of formats of DCI configured for each cell meets a preset limitation condition, to determine the target size of the MC-DCI in the multiple cells.

The process in which the terminal deduces the DCI alignment between different MC-DCI performed by the base station includes: aligning the MC-DCI with a small size to the MC-DCI with a large size in the zero-padding manner. The process in which the terminal deduces the DCI alignment performed by the base station in the at least one of the multiple cells is similar to the implementation manner of the step 302, and will be not repeated herein.

At step 504, the MC-DCI is received and parsed in a scheduling cell based on the target size of the MC-DCI.

In the embodiment of the present disclosure, the scheduling cell refers to a cell in which the terminal actually detects and receives the MC-DCI, and the scheduling cell may be any one of multiple cells scheduled by the MC-DCI, or the scheduling cell may be a cell different from the multiple cells, which is not limited in the present disclosure.

In the above embodiment, the alignment of MC-DCI of different formats is implemented in advance, to ensure the alignment of the sizes of the same multi-cell downlink control information in different scheduled cells, reduce the complexity of the blind detection of the terminal, and improve the transmission performance of the PDCCH. In addition, compared with the first method, when performing the zero-padding, the MC-DCI increases a relatively small number of bits, thereby effectively ensuring the transmission performance of the PDCCH.

In some optional embodiments, when there is a second cell configured with legacy DCI in the multiple cells, and a size of the legacy DCI before performing a DCI alignment is greater than the target size of the MC-DCI for the second cell, it is determined that the DCI alignment is performed on the legacy DCI and the MC-DCI of the target size in the second cell in a truncating manner.

In some optional embodiments, the terminal does not expect that the size of the legacy DCI configured for any one cell is greater than the target size of the MC-DCI.

For example, in a possible implementation manner, before deducing the DCI alignment in each cell, the terminal deduces the alignment between the DCI format 0_3 and the DCI format 1_3. The scheduled cell scheduled by the DCI format 0_3 overlaps with the scheduled cell scheduled by the DCI format 1_3.

In another possible implementation manner, after the MC-DCI format 0_3 is aligned with the format 1_3, the terminal deduces, in at least one of the multiple cells, a DCI alignment on DCI including MC-DCI performed by the base station. For any one cell, when the size of the MC-DCI is configured to be greater than the size of the legacy DCI, considering that the size of the DCI format 0_3 is the same as the size of the DCI format 1_3, the case that the sizes of the MC-DCI are inconsistent due to the DCI alignment is avoided.

In another possible implementation manner, after the MC-DCI format 0_3 is aligned with the format 1_3, the terminal deduces, in at least one of the multiple cells, a DCI alignment on DCI including MC-DCI performed by the base station. When there is a second cell configured with legacy DCI in the multiple cells, in the case where a size of the legacy DCI is greater than the target size of the MC-DCI, the legacy DCI in the second cell may be aligned with the MC-DCI in the truncating manner.

In another possible implementation manner, after the MC-DCI format 0_3 is aligned with the format 1_3, the terminal deduces, in at least one of the multiple cells, the DCI alignment on DCI including MC-DCI performed by the base station. The terminal does not expect that the size of the legacy DCI configured for any one cell is greater than the target size of the MC-DCI.

The DCI sending method provided in the present disclosure is described again from the base station side below.

An embodiment of the present disclosure provides a DCI sending method. Referring to FIG. 6, FIG. 6 is a flowchart of a DCI sending method shown according to an embodiment. The method may be performed by a base station. The method may include the following steps 601-603.

At step 601, multiple cells scheduled by MC-DCI are determined.

In the embodiment of the present disclosure, the MC-DCI is used to schedule data transmission of the multiple cells. The data transmission of each cell corresponds to one PDSCH and/or one PUSCH.

In the embodiment of the present disclosure, the multiple cells scheduled by the same MC-DCI may refer to one or more scheduled cells scheduled by the MC-DCI at the same moment, for example, the multiple cells {cell #1, cell #2, cell #3} scheduled by the MC-DCI (the format of the MC-DCI may be format 0_3 or format 1_3) at the moment t1.

The multiple cells scheduled by the same MC-DCI may also refer to a set of all cells scheduled by the same MC-DCI at different moments from a static or semi-static perspective. For example, the MC-DCI with the format 0_3 supports dynamic handover of scheduled cells, the cells scheduled by the MC-DCI at the moment t1 are {cell #1, cell #2, cell #3}, the cells scheduled by the MC-DCI at the moment t2 are {cell #3, cell #4} , and then the multiple cells scheduled by the same MC-DCI are {cell #1, cell #2, cell #3, cell #4} in the present disclosure.

The multiple cells scheduled by the same MC-DCI may also refer to a set of all cells that may be scheduled by the MC-DCI. For example, when a set of cells that may be scheduled by certain MC-DCI is {cell #1, cell #2, cell #4}, and the MC-DCI may schedule one or more cells in the set of cells, the multiple cells scheduled by the same MC-DCI may refer to all cells included in the set of cells.

At step 602, a target size of the MC-DCI for the multiple cells is determined.

In the embodiment of the present disclosure, the base station performs the DCI alignment, so that in a case where the number of sizes of DCI configured for each of the multiple cells meets a preset limitation condition, a uniform target size of the MC-DCI for the multiple cells is determined.

In the embodiment of the present disclosure, the preset limitation condition may be a limitation condition of “3+1” in a related mechanism, a limitation condition of “4+1”, or another preset limitation condition that needs to be met by the number of sizes of DCI configured for each serving cell, which is not limited in the present disclosure. The limitation condition of “4+1” means that the number of size types of DCI scrambled by C-RNTI in the serving cell does not exceed 4, and the total number of size types of DCI configured for the serving cell does not exceed 5.

At step 603, the MC-DCI is sent to a terminal in a scheduling cell based on the target size of the MC-DCI.

It should be noted that the multiple cells scheduled by the MC-DCI refer to multiple scheduled cells. The scheduling cell refers to a cell in which the terminal actually detects and receives the MC-DCI. The scheduling cell may be any one of the multiple cells (i.e., the multiple scheduled cells), or the scheduling cell may be a cell different from the multiple cells (i.e., the multiple scheduled cells), which is not limited in the present disclosure.

The base station may send the MC-DCI to the terminal in the scheduling cell based on the target size of the MC-DCI determined in the step 602.

In the above embodiment, the alignment of the sizes of the same multi-cell downlink control information in different scheduled cells may be realized, the complexity of the blind detection of the terminal may be reduced, and the transmission performance of the PDCCH may be improved.

An implementation manner of determining the target size of the MC-DCI for the multiple cells is specifically described below.

In a first method, the base station combines the DCI alignment performed in at least one scheduled cell in the multiple cells with the DCI alignment performed across the scheduled cells, such that a target size of the MC-DCI is finally determined, in the case where the number of sizes of DCI configured for each scheduled cell meets the preset limitation condition.

An embodiment of the present disclosure provides a DCI sending method. Referring to FIG. 7, FIG. 7 is a flowchart of a DCI sending method shown according to an embodiment. The method may be performed by a base station. The method may include the following steps 701-704.

At step 701, multiple cells scheduled by MC-DCI are determined.

In the embodiment of the present disclosure, the MC-DCI is used to schedule data transmission of the multiple cells. The data transmission of each cell corresponds to one PDSCH and/or one PUSCH.

In the embodiment of the present disclosure, the multiple cells scheduled by the same MC-DCI may refer to one or more scheduled cells scheduled by the MC-DCI at the same moment, for example, the multiple cells {cell #1, cell #2, cell #3} scheduled by the MC-DCI (the format of the MC-DCI may be format 0_3 or format 1_3) at the moment t1.

The multiple cells scheduled by the same MC-DCI may also refer to a set of all cells scheduled by the same MC-DCI at different moments from a static or semi-static perspective. For example, the MC-DCI with the format 0_3 supports dynamic handover of scheduled cells, the cells scheduled by the MC-DCI at the moment t1 are {cell #1, cell #2, cell #3} , the cells scheduled by the MC-DCI at the moment t2 are {cell #3, cell #4} , and then the multiple cells scheduled by the same MC-DCI are {cell #1, cell #2, cell #3, cell #4} in the present disclosure.

The multiple cells scheduled by the same MC-DCI may also refer to a set of all cells that may be scheduled by the MC-DCI. For example, when a set of cells that may be scheduled by certain MC-DCI is {cell #1, cell #2, cell #4}, and the MC-DCI may schedule one or more cells in the set of cells, the multiple cells scheduled by the same MC-DCI may refer to all cells included in the set of cells.

At step 702, first sizes of the MC-DCI are determined for at least one cell in the multiple cells.

In an embodiment of the present disclosure, the base station performs the DCI alignment on DCI including the MC-DCI for the at least one cell in the multiple cells, such that in the case where the number of sizes of DCI configured for each cell meets a preset limitation condition, the first sizes of the MC-DCI for the at least one cell are determined.

In the related technology, the base station performs the DCI alignment per cell, including but not limited to performing the DCI alignment based on a time-frequency resource of the cell, and may also include performing the DCI alignment on the number of formats of DCI and the number of sizes of DCI configured for the entire cell in a zero-padding manner or in another manner, for example, a truncating manner. For example, after the base station determines that DCI with a certain format after alignment needs to occupy n1 bits, and the size of the DCI determined by the base station is n2 bits, where n2 is less than n1. At this time, the base station may increase the size of the DCI to n1 by padding zero bits. For another example, after the base station determines that DCI with a certain format after alignment needs to occupy n1 bits, and the size of the DCI determined by the base station is n2 bits, where n2 is greater than n1. At this time, the base station may reduce the number of bits in the DCI to n1 in a truncating manner.

In the related technology, the limitation on the size of DCI needs to meet the limitation condition of “3+1”. The limitation condition of “3+1” means that the number of size types of DCI scrambled by C-RNTI in the serving cell does not exceed 3, and the total number of size types of DCI configured for the serving cell does not exceed 4.

However, in the embodiment of the present disclosure, the preset limitation condition may be a limitation condition of “3+1” in a related mechanism, a limitation condition of “4+1”, or another preset limitation condition that needs to be met by the number of sizes of DCI configured for each serving cell, which is not limited in the present disclosure. The limitation condition of “4+1” means that the number of size types of DCI scrambled by C-RNTI in the serving cell does not exceed 4, and the total number of size types of DCI configured for the serving cell does not exceed 5.

In the embodiment of the present disclosure, for the base station side, the cell in which the DCI alignment on DCI including the MC-DCI is performed may be each of the multiple cells, or may be a part of the multiple cells, or may be one of the multiple cells, which is not limited in the present disclosure.

In a possible implementation manner, the base station may perform the DCI alignment on the DCI including the MC-DCI for each of the multiple cells, and determine the first sizes of the MC-DCI in at least one cell in the case where the number of sizes of DCI configured for each cell meets a preset limitation condition.

In another possible implementation manner, the base station may perform the DCI alignment on the DCI including the MC-DCI for one or more specific cells of the multiple cells, and finally determine the first sizes of the MC-DCI in the one or more specific cells in the case where it is ensured that the number of sizes of DCI configured for each of the multiple cells meets a preset limitation condition.

The one or more specific cells may be one or more cells in which the number of sizes of DCI configured for the multiple cells does not meet the preset limitation condition.

In a possible implementation manner, the DCI alignment on the DCI including the MC-DCI may include but is not limited to any one of: a DCI alignment performed on MC-DCI of different formats; a DCI alignment performed on MC-DCI of different formats, and then a further DCI alignment performed on aligned MC-DCI with legacy DCI of at least one format; or a DCI alignment performed on legacy DCI of different formats, and then a further DCI alignment performed on aligned legacy DCI with MC-DCI of at least one format.

The MC-DCI includes, but is not limited to, a new DCI format 0_3: for scheduling PUSCHs for multiple cells; DCI format 1_3: for scheduling PDSCHs of multiple cells; correspondingly, a DCI alignment performed on MC-DCI of different formats may refer to size alignment between the DCI format 0_3 and the DCI format 1_3.

A DCI alignment performed on MC-DCI of different formats, and then a further DCI alignment performed on aligned MC-DCI with legacy DCI of at least one format may mean: performing size alignment between the DCI format 0_3 and the DCI format 1_3, and then performing the size alignment with legacy DCI of at least one format. In the embodiment of the present disclosure, the legacy DCI refers to a DCI format defined based on an existing protocol mechanism (Rel-15, Rel-16, or Rel-17), and the MC-DCI introduced for Rel-18 is not within a range of the legacy DCI.

For example, a DCI alignment performed on MC-DCI of different formats, and then a further DCI alignment performed on aligned MC-DCI with legacy DCI of at least one format may mean: performing size alignment between the DCI format 0_3 and the DCI format 1_3, and then performing the size alignment with the legacy DCI, for example, the DCI format 0_1 and/or the DCI format 1_1.

For another example, a DCI alignment performed on MC-DCI of different formats, and then a further DCI alignment performed on aligned MC-DCI with legacy DCI of at least one format may mean: performing size alignment between the DCI format 0_3 and the DCI format 1_3, and then performing the size alignment with the legacy DCI, for example, the DCI format 0_2 and/or the DCI format 1_2.

A DCI alignment performed on legacy DCI of different formats, and then a further DCI alignment performed on aligned legacy DCI with MC-DCI of at least one format may mean: performing size alignment on legacy DCI of different formats according to a related mechanism, including but not limited to the size alignment between the DCI format 0_1 and the DCI format 1_1, and/or the size alignment between the DCI format 0_2 and the DCI format 1_2, etc., and further performing the size alignment with the DCI format 0_3 and/or the DCI format 1_3.

At step 703, the target size of the MC-DCI for the multiple cells is determined based on the determined first sizes of the MC-DCI for the at least one cell in the multiple cells.

In the embodiment of the present disclosure, the number of the first sizes is equal to the number of cells in which the terminal deduces the DCI alignment performed by the base station. Correspondingly, when there are multiple and different first sizes determined by the MC-DCI in at least one of the multiple cells, the base station may determine a maximum value of the determined first sizes of the MC-DCI for the at least one cell as the target size of the MC-DCI.

At step 704, the MC-DCI is sent to a terminal in a scheduling cell based on the target size of the MC-DCI.

In this embodiment of the present disclosure, after the base station determines the target size of the MC-DCI, the base station needs to reperform, in at least one of the multiple cells, the DCI alignment on DCI including the MC-DCI, so that the number of formats of the DCI configured for each cell meets the preset limitation condition, to determine the size of the DCI configured for each cell. The specific deducing manner is similar to performing the DCI alignment on DCI including the MC-DCI for the at least one cell in the above step 702, and will be not repeated herein.

The cell in which the DCI alignment on DCI including the MC-DCI is performed may be each of the multiple cells, or may be a part of the multiple cells, or may be one of the multiple cells, which is not limited in the present disclosure.

In the embodiment of the present disclosure, when there is a cell configured with legacy DCI in the multiple cells, the size of the legacy DCI is generally smaller than the size of the MC-DCI, that is, the legacy DCI needs to be aligned to the size of the MC-DCI, therefore, after the DCI alignment is reperformed for at least one cell in the multiple cells, the determined size of the MC-DCI is still the target size. The base station may send the MC-DCI to a terminal in a scheduling cell based on the target size of the MC-DCI.

In the embodiment of the present disclosure, the scheduling cell refers to a cell in which the terminal actually detects and receives the MC-DCI, and the scheduling cell may be any one of multiple cells scheduled by the MC-DCI, or the scheduling cell may be a cell different from the multiple cells, which is not limited in the present disclosure.

In the above embodiment, a DCI alignment mechanism between multiple cells scheduled by a same MC-DCI is added, such that the alignment of the sizes of the same multi-cell downlink control information in different scheduled cells is realized, the complexity of the blind detection of the terminal is reduced, and the transmission performance of the PDCCH is improved.

In a second method, for one or more specific cells of the multiple cells scheduled by the MC-DCI, the number of MC-DCI is limited.

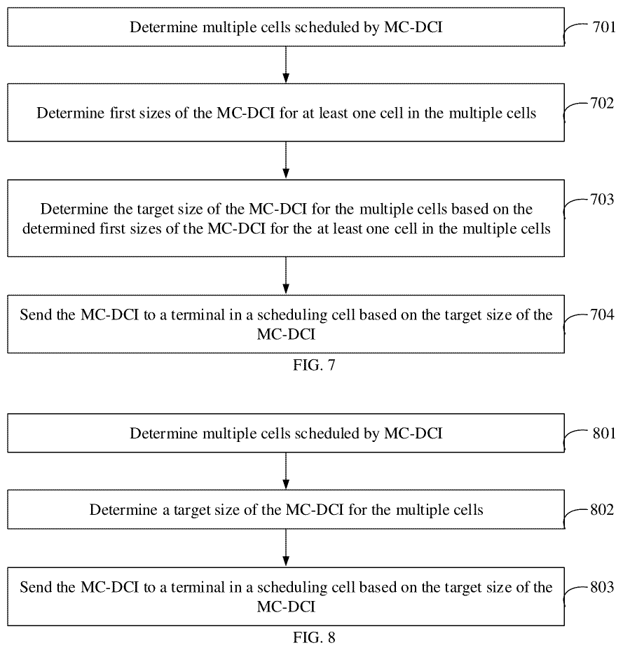

An embodiment of the present disclosure provides a DCI sending method. Referring to FIG. 8, FIG. 8 is a flowchart of a DCI sending method shown according to an embodiment. The method may be performed by a base station. The method may include the following steps 801-803.

At step 801, multiple cells scheduled by MC-DCI are determined.

In the embodiment of the present disclosure, the MC-DCI is used to schedule data transmission of the multiple cells. The data transmission of each cell corresponds to one PDSCH and/or one PUSCH.

In the embodiment of the present disclosure, the multiple cells scheduled by the same MC-DCI may refer to one or more scheduled cells scheduled by the MC-DCI at the same moment, for example, the multiple cells {cell #1, cell #2, cell #3} scheduled by the MC-DCI (the format of the MC-DCI may be format 0_3 or format 1_3) at the moment t1.

The multiple cells scheduled by the same MC-DCI may also refer to a set of all cells scheduled by the same MC-DCI at different moments from a static or semi-static perspective. For example, the MC-DCI with the format 0_3 supports dynamic handover of scheduled cells, the cells scheduled by the MC-DCI at the moment t1 are {cell #1, cell #2, cell #3} , the cells scheduled by the MC-DCI at the moment t2 are {cell #3, cell #4} , and then the multiple cells scheduled by the same MC-DCI are {cell #1, cell #2, cell #3, cell #4} in the present disclosure.

The multiple cells scheduled by the same MC-DCI may also refer to a set of all cells that may be scheduled by the MC-DCI. For example, when a set of cells that may be scheduled by certain MC-DCI is {cell #1, cell #2, cell #4}, and the MC-DCI may schedule one or more cells in the set of cells, the multiple cells scheduled by the same MC-DCI may refer to all cells included in the set of cells.

At step 802, a target size of the MC-DCI for the multiple cells is determined.

In a related mechanism, the DCI alignment is performed by the base station respectively in each of the multiple cells, and after the MC-DCI is introduced, there may be a case that the same MC-DCI corresponds to different sizes after performing the DCI alignment in different scheduled cells. In view of the above problem, it is considered that in most scenarios, the sizes of MC-DCI are larger than the size of the legacy DCI in the present disclosure. The problem of inconsistent sizes of the MC-DCI mainly comes from the alignment between the DCI format 0_3 and the DCI format 1_3. Based on this, in the embodiment of the present disclosure, the number of pieces of the MC-DCI is mainly limited for one or more specific cells in multiple cells scheduled by the MC-DCI, to avoid the alignment between the DCI format 0_3 and the DCI format 1_3 from a perspective of limiting MC-DCI scheduling.

In a possible implementation manner, the base station does not schedule the MC-DCI that the number of formats of the MC-DCI is greater than 1. Correspondingly, for the terminal side, the terminal does not expect to configure MC-DCI of more than one format in any one of the multiple cells scheduled by the same MC-DCI.

In another possible implementation manner, in any one cell, the base station does not perform a DCI alignment between the MC-DCI of different formats, and correspondingly, the terminal does not expect that a preset limitation condition is met through performing a DCI alignment between MC-DCI of different formats in any one cell.

In the embodiment of the present disclosure, the preset limitation condition may be a limitation condition of “3+1” in a related mechanism, a limitation condition of “4+1”, or another preset limitation condition that needs to be met by the number of sizes of DCI configured for each serving cell, which is not limited in the present disclosure.

In another possible implementation manner, in a case where the base station configures one or more pieces of MC-DCI in any one cell, the base station does not change the size of any MC-DCI in an alignment manner, and correspondingly, the terminal does not expect that sizes of the MC-DCI are changed in an alignment manner.

In the present disclosure, for one or more specific cells of the multiple cells scheduled by the MC-DCI, the number of the MC-DCI is limited, so that the determined target size of the MC-DCI for the multiple cells is the same after the base station performs the DCI alignment on the basis of introducing the MC-DCI for at least one cell according to the related mechanism.

It should be noted that, because the size of the MC-DCI corresponding to any one of the multiple cells is not changed in an alignment manner, such as zero-padding or truncating, the base station finally determines the same target size of the MC-DCI in the multiple cells.

At step 803, the MC-DCI is sent to a terminal in a scheduling cell based on the target size of the MC-DCI.

In the embodiment of the present disclosure, the scheduling cell refers to a cell in which the terminal actually detects and receives the MC-DCI, and the scheduling cell may be any one of multiple cells scheduled by the MC-DCI, or the scheduling cell may be a cell different from the multiple cells, which is not limited in the present disclosure.

In the above embodiment, the size of the MC-DCI may be prevented from being changed in an alignment manner, in the scenario in which the MC-DCI is introduced, the DCI alignment is simplified, the alignment of the sizes of the same multi-cell downlink control information in different scheduled cells is realized, the complexity of the blind detection of the terminal is reduced, and the transmission performance of the PDCCH is improved.

In third method, before performing the DCI alignment in at least one of the multiple cells scheduled by the same MC-DCI, the base station performs in advance the DCI alignment on different MC-DCI in a zero-padding manner.

An embodiment of the present disclosure provides a DCI sending method. Referring to FIG. 9, FIG. 9 is a flowchart of a DCI sending method shown according to an embodiment. The method may be performed by a base station. The method may include the following steps 901-904.

At step 901, multiple cells scheduled by MC-DCI are determined.

In the embodiment of the present disclosure, the MC-DCI is used to schedule data transmission of the multiple cells. The data transmission of each cell corresponds to one PDSCH and/or one PUSCH.

In the embodiment of the present disclosure, the multiple cells scheduled by the same MC-DCI may refer to one or more scheduled cells scheduled by the MC-DCI at the same moment, for example, the multiple cells {cell #1, cell #2, cell #3} scheduled by the MC-DCI (the format of the MC-DCI may be format 0_3 or format 1_3) at the moment t1.

The multiple cells scheduled by the same MC-DCI may also refer to a set of all cells scheduled by the same MC-DCI at different moments from a static or semi-static perspective. For example, the MC-DCI with the format 0_3 supports dynamic handover of scheduled cells, the cells scheduled by the MC-DCI at the moment t1 are {cell #1, cell #2, cell #3} , the cells scheduled by the MC-DCI at the moment t2 are {cell #3, cell #4} , and then the multiple cells scheduled by the same MC-DCI are {cell #1, cell #2, cell #3, cell #4} in the present disclosure.

The multiple cells scheduled by the same MC-DCI may also refer to a set of all cells that may be scheduled by the MC-DCI. For example, when a set of cells that may be scheduled by certain MC-DCI is {cell #1, cell #2, cell #4}, and the MC-DCI may schedule one or more cells in the set of cells, the multiple cells scheduled by the same MC-DCI may refer to all cells included in the set of cells.

At step 902, when there are first cells scheduled simultaneously with different MC-DCI for the multiple cells, before determining the target size of the MC-DCI for the multiple cells, the DCI alignment is performed on the different MC-DCI in a zero-padding manner.

In the embodiment of the present disclosure, different MC-DCI may refer to MC-DCI of different formats, for example, the DCI format 0_3 and the DCI format 1_3.

Alternatively, different MC-DCI may refer to MC-DCI that schedules different sets of cells in a same format. It should be noted that any two sets of cells do not include a same cell.

For example, when both two pieces of MC-DCI have the format 0_3, MC-DCI #1 schedules the cell #1 and the cell #2, and MC-DCI #2 schedules the cell #3 and the cell #4, the MC-DCI #1 and the MC-DCI #2 are also different MC-DCI.

At step 903, a target size of the MC-DCI is determined.

In the above first method, the base station first performs the DCI alignment on DCI including MC-DCI in at least one of the multiple cells, and after determining the first size of the MC-DCI in each cell, the base station performs the MC-DCI alignment between scheduled cells (that is, the DCI alignment is performed on the MC-DCI with the first size to the MC-DCI with the target size in a zero-padding manner), and then the base station reperforms the DCI alignment on DCI including MC-DCI in at least one of the multiple cells, and finally determines the size of the MC-DCI as the target size.

However, in the third method, the base station performs in advance the DCI alignment on different MC-DCI, and then performs the DCI alignment in at least one of the multiple cells, so that the number of formats of DCI configured for each cell meets a preset limitation condition, to determine the target size of the MC-DCI.

At step 904, the MC-DCI is sent to a terminal in a scheduling cell based on the target size of the MC-DCI.

In the embodiment of the present disclosure, the scheduling cell refers to a cell in which the terminal actually detects and receives the MC-DCI, and the scheduling cell may be any one of multiple cells scheduled by the MC-DCI, or the scheduling cell may be a cell different from the multiple cells, which is not limited in the present disclosure.

In the above embodiment, the alignment of MC-DCI of different formats is implemented in advance, to ensure the alignment of the sizes of the same multi-cell downlink control information in different scheduled cells, reduce the complexity of the blind detection of the terminal, and improve the transmission performance of the PDCCH. In addition, compared with the first method, when performing the zero-padding, the MC-DCI increases a relatively small number of bits, thereby effectively ensuring the transmission performance of the PDCCH.

In some optional embodiments, when there is a second cell configured with legacy DCI in the multiple cells, and a size of the legacy DCI before performing the DCI alignment is greater than the target size of the MC-DCI for the second cell, the base station performs the DCI alignment on the legacy DCI and the MC-DCI of the target size in the second cell in a truncating manner.

In some optional embodiments, the base station does not configure legacy DCI with a size greater than the target size in any one cell.

The specific implementation manner is similar to that described on the terminal side, and will be not repeated herein.

To facilitate understanding of the DCI receiving and sending methods provided in the present disclosure, the above solutions are further described from the perspective of the terminal as follows.

It is assumed that the terminal is a Rel-18 and a subsequent version of terminal, the terminal receives DCI used to schedule data transmission of multiple cells, that is, MC-DCI, and the terminal receives data of PDSCHs of the multiple cells or transmits data of PUSCHs of the multiple cells based on indication information for the DCI.

A new DCI format is introduced, for example, the DCI format is a DCI format 0_3: for scheduling PUSCHs of multiple cells, or the DCI format is a DCI format 1_3: for scheduling PDSCHs of multiple cells. The DCI format 0_3/DCI format 1_3 may be scrambled by a C-RNTI, or may be scrambled by a newly defined RNTI, which is not limited in the present disclosure.

In the present disclosure, a DCI alignment mechanism is designed mainly by considering introduction of MC-DCI, so that for each of multiple scheduled cells, the number of sizes of configured DCI meets a preset limitation condition, and a same MC-DCI corresponds to a same size.

From the perspective of the base station, the DCI alignment means that the base station implements consistent sizes of different DCI in a manner such as the zero-padding or truncating based on the DCI alignment mechanism. The different DCI includes but is not limited to: DCI of different formats, or DCI with the same format but corresponding to different functions, which is not limited in the present disclosure.

After determining the size of the DCI in a manner such as zero-padding or truncating, the base station sends the DCI to indicate the corresponding scheduling information. From the perspective of the terminal, the DCI alignment means that the terminal deduces the DCI alignment performed by the base station based on the DCI alignment mechanism, and determines a size of the configured DCI, thereby implementing blind detection of the DCI.

In the present disclosure, the DCI format #1 is aligned with the DCI format #2, and from the perspective of the terminal side, the terminal determines the sizes of the DCI format #1 and the DCI format #2 based on the alignment between the DCI format #1 and the DCI format #2, instead of the terminal performing the alignment such as the zero-padding or truncating, which will not be repeated in the present disclosure.

In the present disclosure, a DCI alignment mechanism is designed mainly by considering introduction of MC-DCI, so that for each of multiple scheduled cells, the number of sizes of configured DCI meets a preset limitation condition. The preset limitation condition may be a limitation condition of “3+1”, that is, the number of sizes of DCI configured for the cell and scrambled by the C-RNTI is not greater than 3, and the total number of sizes of DCI configured for the cell is not greater than 4. Of course, the preset limitation condition may also be a limitation condition of “4+1”, or another limitation condition, which is not limited in the present disclosure. Subsequently, the solutions of the present disclosure will be described by taking “3+1” as an example. It can be understood that other limitations are also applicable to the solutions of the present disclosure.

In a first embodiment, as described above, this embodiment mainly considers that after the MC-DCI is introduced, a DCI alignment mechanism is designed to ensure that the number of sizes of DCI configured for each cell scheduled by the MC-DCI meets the limitation condition of “3+1”.

Considering that in an existing mechanism, the DCI alignment is performed in each (scheduled) cell respectively, and after the MC-DCI is introduced, there may be a case that the same MC-DCI corresponds to different sizes after performing the DCI alignment in different cells. In view of the above problem, a mechanism for performing respectively the DCI alignment in each scheduled cell (or, per scheduled cell) and between scheduled cells is designed in this embodiment, and specific implementation solutions are as follows.

The DCI alignment on DCI including MC-DCI is performed respectively in each (scheduled) cell. Alternatively, the DCI alignment on DCI including MC-DCI may be performed in at least one specific cell.

The DCI alignment performed on DCI including MC-DCI may be: performing the alignment between the MC-DCI format 0_3 and the DCI format 1_3, and then the alignment with the DCI format 0_1/1_1; performing the legacy DCI alignment based on an existing mechanism, and then the alignment with the DCI format 0_3/DCI format 1_3; performing the alignment between the MC-DCI format 0_3 and the DCI format 1_3, and then the alignment with other legacy DCI formats (the other legacy DCI formats may be the DCI format 0_2 and/or the DCI format 1_2), which is not limited in the present disclosure.

For multiple (scheduled) cells scheduled by the same MC-DCI, when different scheduled cells correspond to different first sizes of the MC-DCI after the DCI alignment in each scheduled cell, the alignment is performed to the MC-DCI corresponding to the maximum value of the first sizes. The alignment manner may be the zero-padding or zero-padding of a corresponding field, which is not limited in the present disclosure.

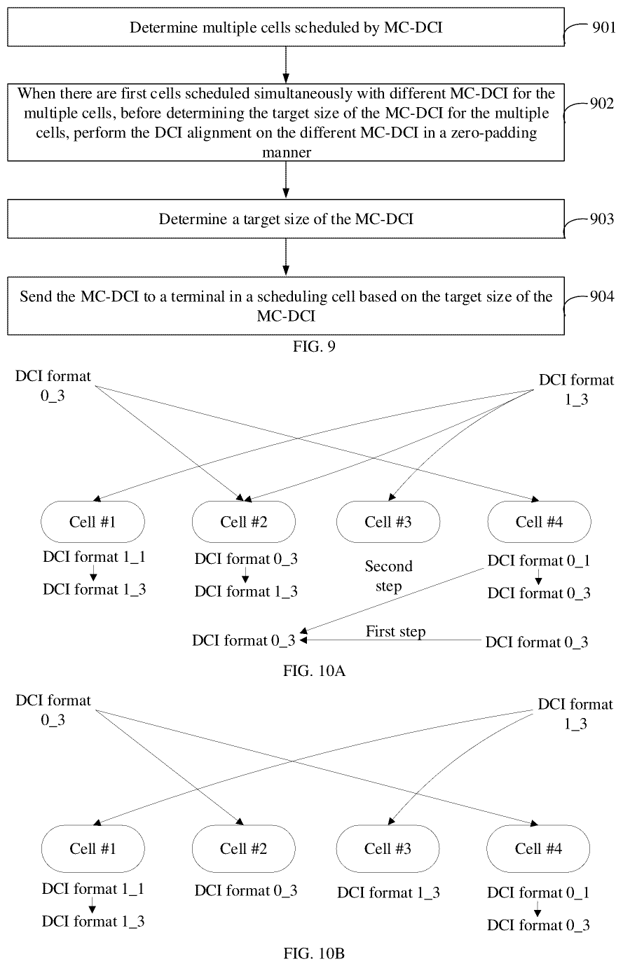

For example, as shown in FIG. 10A, in the first step, because the MC-DCI in the cell #2, that is, the DCI format 0_3, is aligned with the DCI format 1_3 in the zero-padding manner, the size of the DCI format 0_3 in the cell #2 is different from the size of the DCI format 0_3 corresponding to the cell #4. Then, the DCI format 0_3 configured for the cell #4 is aligned with the DCI format 0_3 configured for the cell #2 in the zero-padding manner.

In the step 2, the sizes of the MC-DCI of each (scheduled) cell of the multiple cells are determined to be the same size in the above manner.

The DCI alignment is re-performed on the legacy DCI other than the MC-DCI in each scheduled cell based on the newly determined size of MC-DCI, to meet the limitation condition of “3+1”. In FIG. 10A, for the cell #4, the DCI format 0_1 is aligned with the DCI format 0_3 with the redetermined size in the zero-padding manner (the redetermined size is a maximum value of the first sizes, that is, the target size).

In the solutions of the present disclosure, the legacy DCI refers to a DCI format defined based on an existing protocol mechanism (Rel-15/16/17), and the MC-DCI introduced for Rel-18 is not within a range of the legacy DCI.

In the solution of the present disclosure, multiple cells scheduled by a same MC-DCI may refer to one or more cells scheduled by the DCI format 0_3 or DCI format 1_3 at the same moment, or may refer to a set of all cells scheduled by the same MC-DCI at different moments from a static or semi-static perspective, or may refer to a set of cells that may be scheduled by the MC-DCI.

According to the above embodiments, an MC-DCI alignment mechanism between scheduled cells is added, so that the number of sizes of DCI configured for each cell meets a limitation condition of “3+1”, and an existing standard mechanism is followed, thereby effectively reducing complexity of blind detection performed by the terminal on the DCI.

In a second embodiment, as described in the first embodiment, in an existing mechanism, the DCI alignment is performed in each scheduled cell respectively, and after the MC-DCI is introduced, there may be a case that the same MC-DCI corresponds to different sizes after performing the DCI alignment in different scheduled cells. In view of the above problem, it is considered that in most scenarios, the sizes of MC-DCI are larger than the size of the legacy DCI in embodiments of the present disclosure. In the above scenario, the problem of inconsistent sizes of the MC-DCI mainly comes from the alignment between the DCI format 0_3 and the DCI format 1_3. Based on this, in the embodiment of the present disclosure, for a specific scheduled cell, occurrence of the alignment between the DCI format 0_3 and the DCI format 1_3 is mainly avoided from a perspective of limiting MC-DCI scheduling.

In a possible implementation manner, the terminal does not expect that the number of formats of the MC-DCI configured for any one cell is greater than 1. For example, as shown in FIG. 10B, the cell #1 is scheduled by the DCI format 1_3 and is not be scheduled by the DCI format 0_3; and the cell #4 is scheduled by the DCI format 0_3 and is not be scheduled by the DCI format 1_3.

In a possible implementation manner, the terminal does not expect that the DCI configured for any one cell needs to meet the limitation condition of “3+1” through the alignment between the DCI format 0_3 and the DCI format 1_3.

In a possible implementation manner, in a case where one or more pieces of MC-DCI are configured for any one cell, the terminal does not expect that sizes of the MC-DCI are changed in an alignment manner, such as the zero-padding or truncating.

In the above embodiment, sizes of the MC-DCI are avoided from being changed through the alignment by limiting the configuration manner of the MC-DCI in the scheduled cell, thereby simplifying the DCI alignment and reducing the complexity of the blind detection of the terminal.

In a third embodiment, as described in the first embodiment, in an existing mechanism, the DCI alignment is performed in each scheduled cell respectively, and after the MC-DCI is introduced, there may be a case that the same MC-DCI corresponds to different sizes after performing the DCI alignment in different scheduled cells. For the above problem, the design solutions of the embodiments of the present disclosure consider a manner of combining the DCI alignment between multiple scheduled cells with the DCI alignment in each scheduled cell, where the MC-DCI alignment between the scheduled cells is performed before the DCI alignment in each scheduled cell.

In a possible implementation manner, before the DCI alignment in each scheduled cell, the alignment between the MC-DCI format 0_3 and the DCI format 1_3 is performed. The scheduled cell scheduled by the DCI format 0_3 overlaps with the scheduled cell scheduled by the DCI format 1_3. One or more scheduled cells refer to one or more of the multiple cells scheduled by the same MC-DCI. The multiple cells may refer to one or more scheduled cells scheduled by the MC-DCI at the same moment, or may refer to a set of all cells scheduled by the same MC-DCI at different moments from a static or semi-static perspective, or may refer to a set of all cells that may be scheduled by the MC-DCI.

In a possible implementation manner, after the MC-DCI format 0_3 is aligned with the DCI format 1_3, the DCI alignment is performed in each scheduled cell. For a specific serving cell, when the sizes of the MC-DCI are configured to be greater than the size of the legacy DCI, considering that the size of the DCI format 0_3 is the same as the size of the DCI format 1_3, the case that sizes of the MC-DCI are inconsistent due to the DCI alignment does not occur.

In a possible implementation manner, after the MC-DCI format 0_3 is aligned with the DCI format 1_3, the DCI alignment is performed in each scheduled cell. For a specific serving cell, when there is the case that a size of the configured legacy DCI is greater than the size of the MC-DCI, the legacy DCI may be aligned with the MC-DCI in the truncating manner.

In a possible implementation manner, after the MC-DCI format 0_3 is aligned with the DCI format 1_3, the DCI alignment is performed in each scheduled cell. The terminal does not expect that the size of the configured legacy DCI is greater than the sizes of the MC-DCI, in a cell configured with the MC-DCI.

In the above embodiment, the pre-alignment is performed on the DCI format 0_3/1_3, and under the condition that the size of the MC-DCI is greater than the size of the legacy DCI, the problem of misalignment of sizes of the same MC-DCI is mainly caused by the change of the size of the DCI format 0_3/1_3 due to the alignment between the DCI format 0_3/ DCI format 1_3. Pre-implementation of alignment of 0_3 and 1_3 may solve the above problems. Under the condition that the size of the MC-DCI is smaller than the size of the specific legacy DCI, the manner of aligning the legacy DCI with the MC-DCI through truncating can also avoid the size of the MC-DCI from being changed.

Corresponding to the above embodiments of DCI receiving and sending methods, the present disclosure further provides embodiments of DCI receiving and sending apparatuses.

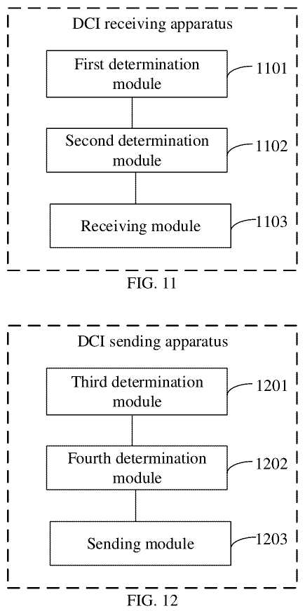

Referring to FIG. 11, FIG. 11 is a block diagram of a DCI receiving apparatus shown according to an exemplary embodiment. The apparatus is applied to a terminal and includes:
a first determination module 1101, configured to determine multiple cells scheduled by multi-cell downlink control information (MC-DCI);
a second determination module 1102, configured to determine a target size of the MC-DCI in the multiple cells; and
a receiving module 1103, configured to receive and parse the MC-DCI in a scheduling cell based on the target size of the MC-DCI.

Optionally, the second determination module is further configured to:
determine first sizes of the MC-DCI for at least one cell in the multiple cells; and
determine the target size of the MC-DCI based on the determined first sizes of the MC-DCI for the at least one cell in the multiple cells.

Optionally, the second determination module is further configured to:
determine the first sizes of the MC-DCI for the at least one cell, in a case where the number of sizes of DCI configured for each of the multiple cells meets a preset limitation condition based on a DCI alignment performed on DCI including the MC-DCI for the at least one cell.

Optionally, the DCI alignment performed on the DCI including the MC-DCI includes any one of:
a DCI alignment performed on MC-DCI of different formats;
a DCI alignment performed on MC-DCI of different formats, and then a further DCI alignment performed on aligned MC-DCI with legacy DCI of at least one format; or
a DCI alignment performed on legacy DCI of different formats, and then a further DCI alignment performed on aligned legacy DCI with MC-DCI of at least one format.

Optionally, the second determination module is further configured to:
take a maximum value of the determined first sizes of the MC-DCI for the at least one cell as the target size of the MC-DCI.

Optionally, the apparatus further includes:
a fifth determination module, configured to, when the determined first sizes of the MC-DCI for the at least one cell are different, determine that a DCI alignment is performed on the MC-DCI of the first sizes to the MC-DCI of the target size in a zero-padding manner.

Optionally, the apparatus further includes at least one of:
a first management module, configured to not expect, by the terminal, that the number of formats of the MC-DCI configured for any one cell is greater than 1;
a second management module, configured to not expect, by the terminal, that a preset limitation condition is met through performing a DCI alignment between MC-DCI of different formats in any one cell; or
a third management module, configured to, in a case where one or more pieces of MC-DCI are configured for any one cell, not expect, by the terminal, that sizes of the MC-DCI are changed in an alignment manner.

Optionally, the apparatus further includes:
a sixth determination module, configured to, when there are first cells scheduled simultaneously with different MC-DCI for the multiple cells, before determining the target size of the MC-DCI, determine that a DCI alignment is performed on the different MC-DCI in a zero-padding manner.

Optionally, the apparatus further includes:
a seventh determination module, configured to, when there is a second cell configured with legacy DCI in the multiple cells, and a size of the legacy DCI before a DCI alignment is greater than the target size of the MC-DCI for the second cell, determine that the DCI alignment is performed on the legacy DCI and the MC-DCI of the target size in the second cell in a truncating manner.

Optionally, the apparatus further includes:
a fourth management module, configured to not expect, by the terminal, that the size of the legacy DCI configured for any one cell is greater than the target size of the MC-DCI.

Referring to FIG. 12, FIG. 12 is a block diagram of a DCI sending apparatus shown according to an exemplary embodiment. The apparatus is applied to a base station and includes:
a third determination module 1201, configured to determine multiple cells scheduled by multi-cell downlink control information (MC-DCI);
a fourth determination module 1202, configured to determine a target size of the MC-DCI in the multiple cells; and
a sending module 1203, configured to send the MC-DCI to a terminal in a scheduling cell based on the target size of the MC-DCI.

Optionally, the fourth determination module is further configured to:
determine first sizes of the MC-DCI for at least one cell in the multiple cells; and
determine the target size of the MC-DCI based on the determined first sizes of the MC-DCI for the at least one cell in the multiple cells.

Optionally, the fourth determination module is further configured to:
perform a DCI alignment on DCI including the MC-DCI for the at least one cell, such that the number of sizes of DCI configured for each of the multiple cells meets a preset limitation condition; and determine the first sizes of the MC-DCI for the at least one cell.

Optionally, the DCI alignment performed on the DCI including the MC-DCI includes any one of:
a DCI alignment performed on MC-DCI of different formats;
a DCI alignment performed on MC-DCI of different formats, and then a further DCI alignment performed on aligned MC-DCI with legacy DCI of at least one format; or
a DCI alignment performed on legacy DCI of different formats, and then a further DCI alignment performed on aligned legacy DCI with MC-DCI of at least one format.

Optionally, the fourth determination module is further configured to:
take a maximum value of the determined first sizes of the MC-DCI for the at least one cell as the target size of the MC-DCI.

Optionally, the apparatus further includes:
a first performing module, configured to, when the determined first sizes of the MC-DCI for the at least one cell are different, perform a DCI alignment on the MC-DCI of the first sizes to the MC-DCI of the target size in a zero-padding manner.

Optionally, the apparatus further includes at least one of:
a fifth management module, configured to not schedule, by the base station, MC-DCI that the number of formats of the MC-DCI is greater than 1 in any one cell;
a sixth management module, configured to not perform, by the base station, a DCI alignment between MC-DCI of different formats in any one cell; or
a seventh management module, configured to, in a case where one or more pieces of MC-DCI are configured for any one cell, not change, by the base station, that a size of any one of the one or more pieces of the MC-DCI in an alignment manner.

Optionally, the apparatus further includes:
a second performing module, configured to, when there are first cells scheduled simultaneously with different MC-DCI for the multiple cells, before determining the target size of the MC-DCI, perform a DCI alignment on the different MC-DCI in a zero-padding manner.

Optionally, the apparatus further includes:
a third performing module, configured to, when there is a second cell configured with legacy DCI in the multiple cells, and a size of the legacy DCI is greater than the target size of the MC-DCI for the second cell, perform the DCI alignment on the legacy DCI and the MC-DCI of the target size in the second cell in a truncating manner.

Optionally, the apparatus further includes:
an eighth management module, configured to not configure, by the base station, legacy DCI with a size greater than the target size in any one cell.

Since the embodiments of the apparatuses substantially corresponds to the embodiments of the methods, and the related contents may refer to the description of the embodiments of the methods. The apparatus embodiments described above are only schematic. The units explained as separate components may be or may not be physically separated, and the components displayed as units may be or may not be physical units, that is, they may be located in one place or may be distributed across multiple network units. A part or all of modules may be selected according to actual needs to achieve the purpose of the solutions in the present disclosure. Those skilled in the art may understand and implement other embodiments without a creative work.

Correspondingly, the present disclosure further provides a computer readable storage medium. The computer readable storage medium stores a computer program, and the computer program is configured to perform any one DCI receiving method for the terminal side.

Correspondingly, the present disclosure further provides a computer readable storage medium. The computer readable storage medium stores a computer program, and the computer program is configured to perform any one DCI sending method for the base station side.

Correspondingly, the present disclosure further provides a DCI receiving apparatus, including:
a processor; and
a memory configured to store instructions executable by the processor;
where the processor is configured to perform any one DCI receiving method for the terminal side.

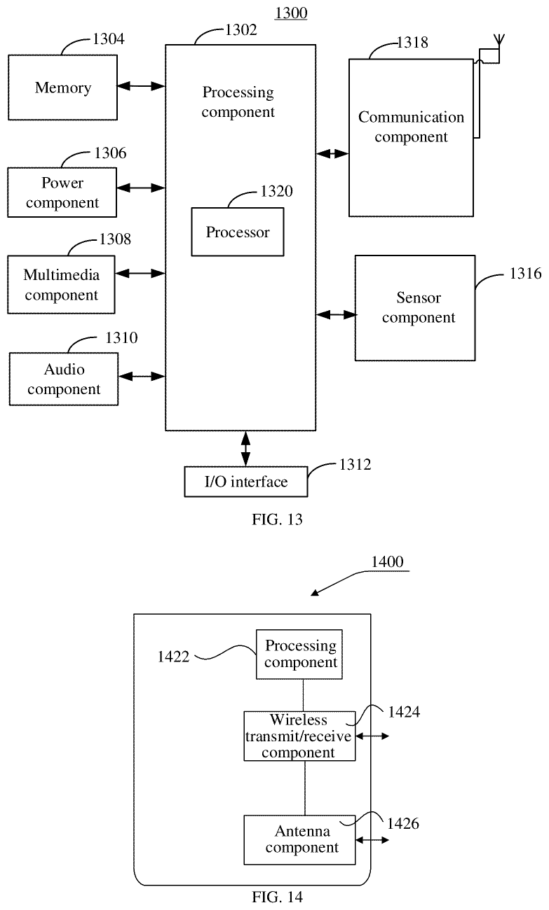

FIG. 13 is a block diagram of a DCI receiving apparatus 1300 shown according to an exemplary embodiment. For example, the apparatus 1300 may be a terminal, such as a mobile phone, a tablet computer, an e-book reader, a multimedia playing device, a wearable device, a vehicle-mounted user equipment, an ipad, a smart television, etc.

Referring to FIG. 13, the apparatus 1300 may include one or more of the following components: a processing component 1302, a memory 1304, a power component 1306, a multimedia component 1308, an audio component 1310, an input/output (I/O) interface 1312, a sensor component 1316, and a communication component 1318.

The processing component 1302 typically controls the overall operation of the apparatus 1300, such as operations associated with display, phone calls, data random accesses, camera operations, and recording operations. The processing component 1302 may include one or more processors 1320 to execute instructions to complete all or part of the steps in the above DCI receiving method. Additionally, the processing component 1302 may include one or more modules to facilitate interaction between the processing component 1302 and other components. For example, the processing component 1302 may include a multimedia module to facilitate interaction between the multimedia component 1308 and the processing component 1302. For another example, the processing component 1302 may read executable instructions from a memory, to implement steps of the DCI receiving method provided in the above embodiments.

The memory 1304 is configured for storing various types of data to support operations of the apparatus 1300. Examples of such data include instructions, contact data, phonebook data, messages, pictures, videos, etc., for any application program or method operating on the apparatus 1300. The memory 1304 may be realized by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 1306 provides power to various components of the apparatus 1300. The power component 1306 may include a power supply management system, one or more power supplies, and other components that are associated with generating, managing, and distributing power for the apparatus 1300.

The multimedia component 1308 includes a display screen providing an output interface between the apparatus 1300 and the user. In some embodiments, the multimedia component 1308 includes a front facing camera and/or a rear facing camera. When the apparatus 1300 is in an operation mode, such as a shooting mode or a video mode, the front facing camera and/or the rear facing camera may receive external multimedia data. Each of the front facing camera and rear facing camera may be a fixed optical lens system or has a focal length and an optical zoom capability.

The audio component 1310 is configured to output and/or input audio signals. For example, the audio component 1310 includes a microphone (MIC). The microphone is configured to receive external audio signals when the apparatus 1300 is in the operating mode, such as a call mode, a recording mode, and a speech recognition mode. The received audio signals may be further stored in the memory 1304 or sent via the communication component 1318. In some embodiments, the audio component 1310 also includes a speaker for outputting the audio signals.

The I/O interface 1312 provides an interface between the processing component 1302 and peripheral interface modules. The peripheral interface modules may be keyboards, click wheels, buttons, etc. These buttons may include but are not limited to: a home button, a volume button, a start button, and a lock button.

The sensor component 1316 includes one or more sensors to provide various aspects of state assessment for the apparatus 1300. For example, the sensor component 1316 may detect an open/closed state of the apparatus 1300, relative positioning of components that are for example a display and keypad of the apparatus 1300. The sensor component 1316 may also detect a position change of the apparatus 1300 or of a component of the apparatus 1300, presence or absence of the user contacting with the apparatus 1300, an orientation or acceleration/deceleration of the apparatus 1300, and a temperature change of the apparatus 1300. The sensor component 1316 may include a proximity sensor configured to detect the presence of nearby objects without any physical contact. The sensor component 1316 may also include a light sensor, such as a CMOS or CCD image sensor, for use in an imaging application. In some embodiments, the sensor component 1316 may also include an acceleration sensor, a gyroscope sensor, a magnetic sensor, a pressure sensor, or a temperature sensor.

The communication component 1318 is configured for facilitating wired or wireless communication between the apparatus 1300 and other devices. The apparatus 1300 may access a wireless network based on a communication standard, such as Wi-Fi, 2G, 3G, 4G, 5G, 6G, or a combination of them. In an exemplary embodiment, the communication component 1318 receives, via a broadcast channel, a broadcast signal or broadcast related information from an external broadcast management system. In an exemplary embodiment, the communication component 1318 further includes a near-field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the apparatus 1300 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform any one DCI receiving method for the terminal side.

In an exemplary embodiment, a non-transitory machine-readable storage medium including instructions is further provided, such as the memory 1304 including the instructions. The above instructions may be executed by the processor 1320 of the apparatus 1300 to complete the above DCI receiving method. For example, the non-transitory computer-readable storage medium may be a ROM, a random access memory (RAM), a CD-ROM, a magnetic tape, a floppy disk, an optical data storage device, etc.

Correspondingly, the present disclosure further provides a DCI sending apparatus, including:
a processor; and
a memory configured to store instructions executable by the processor;
where the processor is configured to perform any one DCI sending method for the base station side.

As shown in FIG. 14, FIG. 14 is a schematic structural diagram of a DCI sending apparatus 1400 shown according to an exemplary embodiment. The apparatus 1400 may be provided as the base station. Referring to FIG. 14, the apparatus 1400 includes a processing component 1422, a wireless transmit/receive component 1424, an antenna component 1426, and a signal processing part specific to a wireless interface. The processing component 1422 may further include at least one processor.

One processor of the processing component 1422 may be configured to perform any one DCI sending method.

According to a first aspect of embodiments of the present disclosure, a DCI receiving method is provided. The method is performed by a terminal and includes: determining multiple cells scheduled by multi-cell downlink control information (MC-DCI); determining a target size of the MC-DCI for the multiple cells; and receiving and parsing the MC-DCI in a scheduling cell based on the target size of the MC-DCI.

Optionally, determining a target size of the MC-DCI for the multiple cells, includes: determining first sizes of the MC-DCI for at least one cell in the multiple cells; and determining the target size of the MC-DCI based on the determined first sizes of the MC-DCI for the at least one cell in the multiple cells.

Optionally, determining first sizes of the MC-DCI for at least one cell in the multiple cells, includes: determining the first sizes of the MC-DCI for the at least one cell, in a case where the number of sizes of DCI configured for each of the multiple cells meets a preset limitation condition based on a DCI alignment performed on DCI including the MC-DCI for the at least one cell.

Optionally, the DCI alignment performed on the DCI including the MC-DCI includes any one of: a DCI alignment performed on MC-DCI of different formats; a DCI alignment performed on MC-DCI of different formats, and then a further DCI alignment performed on aligned MC-DCI with legacy DCI of at least one format; or a DCI alignment performed on legacy DCI of different formats, and then a further DCI alignment performed on aligned legacy DCI with MC-DCI of at least one format.

Optionally, determining the target size of the MC-DCI based on the determined first sizes of the MC-DCI for the at least one cell in the multiple cells, includes: taking a maximum value of the determined first sizes of the MC-DCI for the at least one cell as the target size of the MC-DCI.

Optionally, the method further includes: when the determined first sizes of the MC-DCI for the at least one cell are different, determining that a DCI alignment is performed on the MC-DCI of the first sizes to the MC-DCI of the target size in a zero-padding manner.

Optionally, the method further includes at least one of: not expecting, by the terminal, that the number of formats of the MC-DCI configured for any one cell is greater than 1; not expecting, by the terminal, that a preset limitation condition is met through performing a DCI alignment between MC-DCI of different formats in any one cell; or in a case where one or more pieces of MC-DCI are configured for any one cell, not expecting, by the terminal, that sizes of the MC-DCI are changed in an alignment manner.

Optionally, the method further includes: when there are first cells scheduled simultaneously with different MC-DCI for the multiple cells, before determining the target size of the MC-DCI, determining that a DCI alignment is performed on the different MC-DCI in a zero-padding manner.

Optionally, the method further includes: when there is a second cell configured with legacy DCI in the multiple cells, and a size of the legacy DCI before a DCI alignment is greater than the target size of the MC-DCI for the second cell, determining that the DCI alignment is performed on the legacy DCI and the MC-DCI of the target size in the second cell in a truncating manner.

Optionally, the method further includes: not expecting, by the terminal, that the size of the legacy DCI configured for any one cell is greater than the target size of the MC-DCI.

According to a second aspect of embodiments of the present disclosure, a DCI sending method is provided. The method is performed by a base station and includes: determining multiple cells scheduled by multi-cell downlink control information (MC-DCI); determining a target size of the MC-DCI for the multiple cells; and sending the MC-DCI to a terminal in a scheduling cell based on the target size of the MC-DCI.

Optionally, determining a target size of the MC-DCI for the multiple cells, includes: determining first sizes of the MC-DCI for at least one cell in the multiple cells; and determining the target size of the MC-DCI based on the determined first sizes of the MC-DCI for the at least one cell in the multiple cells.

Optionally, determining first sizes of the MC-DCI for at least one cell in the multiple cells, includes: performing a DCI alignment on DCI including the MC-DCI for the at least one cell, such that the number of sizes of DCI configured for each of the multiple cells meets a preset limitation condition; and determine the first sizes of the MC-DCI for the at least one cell.

Optionally, the DCI alignment performed on the DCI including the MC-DCI includes any one of: a DCI alignment performed on MC-DCI of different formats; a DCI alignment performed on MC-DCI of different formats, and then a further DCI alignment performed on aligned MC-DCI with legacy DCI of at least one format; or a DCI alignment performed on legacy DCI of different formats, and then a further DCI alignment performed on aligned legacy DCI with MC-DCI of at least one format.

Optionally, determining the target size of the MC-DCI based on the determined first sizes of the MC-DCI for the at least one cell in the multiple cells, includes: taking a maximum value of the determined first sizes of the MC-DCI for the at least one cell as the target size of the MC-DCI.

Optionally, the method further includes: when the determined first sizes of the MC-DCI for the at least one cell are different, performing a DCI alignment on the MC-DCI of the first sizes to the MC-DCI of the target size in a zero-padding manner.

Optionally, the method further includes at least one of: not scheduling, by the base station, MC-DCI that the number of formats of the MC-DCI is greater than 1 in any one cell; not performing, by the base station, a DCI alignment between MC-DCI of different formats in any one cell; or in a case where one or more pieces of MC-DCI are configured for any one cell, not changing, by the base station, that a size of any one of the one or more pieces of the MC-DCI in an alignment manner.

Optionally, the method further includes: when there are first cells scheduled simultaneously with different MC-DCI for the multiple cells, before determining the target size of the MC-DCI, performing a DCI alignment on the different MC-DCI in a zero-padding manner.

Optionally, the method further includes: when there is a second cell configured with legacy DCI in the multiple cells, and a size of the legacy DCI is greater than the target size of the MC-DCI for the second cell, performing a DCI alignment on the legacy DCI and the MC-DCI of the target size in the second cell in a truncating manner.

Optionally, the method further includes: not configuring, by the base station, legacy DCI with a size greater than the target size in any one cell.

According to a third aspect of embodiments of the present disclosure, a computer readable storage medium is provided. The computer readable storage medium stores a computer program, and the computer program is configured to perform the above any one DCI receiving method.

According to a fourth aspect of embodiments of the present disclosure, a computer readable storage medium is provided. The computer readable storage medium stores a computer program, and the computer program is configured to perform the above any one DCI sending method.

According to a fifth aspect of embodiments of the present disclosure, a DCI receiving apparatus is provided. The apparatus includes: a processor; and a memory configured to store instructions executable by the processor; where the processor is configured to perform the above any one DCI receiving method.

According to a sixth eighth aspect of embodiments of the present disclosure, a DCI sending apparatus is provided. The apparatus includes: a processor; and a memory configured to store instructions executable by the processor; where the processor is configured to perform the above any one DCI sending method.

According to a seven aspect of embodiments of the present disclosure, a DCI receiving apparatus is provided. The apparatus is applied to a terminal and includes: a first determination module, configured to determine multiple cells scheduled by multi-cell downlink control information (MC-DCI); a second determination module, configured to determine a target size of the MC-DCI in the multiple cells; and a receiving module, configured to receive and parse the MC-DCI in a scheduling cell based on the target size of the MC-DCI.

According to an eighth aspect of embodiments of the present disclosure, a DCI sending apparatus is provided. The apparatus is applied to a base station and includes: a third determination module, configured to determine multiple cells scheduled by multi-cell downlink control information (MC-DCI); a fourth determination module, configured to determine a target size of the MC-DCI in the multiple cells; and a sending module, configured to send the MC-DCI to a terminal in a scheduling cell based on the target size of the MC-DCI.

Those skilled in the art will easily come up with other implementation solutions of the present disclosure after considering the specification and practicing the present disclosure disclosed herein. The present disclosure aims to cover any variations, uses, or adaptive changes of the present disclosure, which follow general principles of the present disclosure and include common knowledge or customary technical means in the art not disclosed in the present disclosure. The specification and embodiments are only considered exemplary, and the true scope and spirit of the present disclosure are indicated by the following claims.

It should be understood that the present disclosure is not limited to the precise structure described above and shown in the accompanying drawings, and various modifications and changes may be made without departing from its scope. The scope of the present disclosure is limited only by the appended claims.

1. A downlink control information (DCI) receiving method, performed by a terminal and comprising:
determining multiple cells scheduled by multi-cell downlink control information (MC-DCI);
determining a target size of the MC-DCI for the multiple cells; and
receiving and parsing the MC-DCI in a scheduling cell based on the target size of the MC-DCI.

2. The method of claim 1, wherein the determining a target size of the MC-DCI for the multiple cells, comprises:
determining, for at least one cell in the multiple cells, one or more first sizes of the MC-DCI; and
determining the target size of the MC-DCI based on the determined one or more first sizes.

3. The method of claim 2, wherein the determining, for at least one cell in the multiple cells, one or more first sizes of the MC-DCI, comprises:
determining the one or more first sizes of the MC-DCI for the at least one cell, in a case where a number of sizes of DCI configured for each of the multiple cells meets a preset limitation condition based on a DCI alignment performed on DCI comprising the MC-DCI for the at least one cell.

4. The method of claim 3, wherein the DCI alignment performed on the DCI comprising the MC-DCI comprises any one of:
a DCI alignment performed on MC-DCI of different formats;
a DCI alignment performed on MC-DCI of different formats, and then a further DCI alignment performed on aligned MC-DCI with legacy DCI of at least one format; or
a DCI alignment performed on legacy DCI of different formats, and then a further DCI alignment performed on aligned legacy DCI with MC-DCI of at least one format.

5. The method of claim 2, wherein the determining the target size of the MC-DCI based on the determined one or more first sizes comprises:
taking a maximum value of the determined one or more first sizes as the target size of the MC-DCI.

6. The method of claim 2, further comprising:
when the determined first sizes are different, determining that a DCI alignment is performed on the MC-DCI of the first sizes to the MC-DCI of the target size in a zero-padding manner.

7. The method of claim 1, further comprising at least one of:
not expecting, by the terminal, that a number of formats of the MC-DCI configured for any one cell is greater than 1;
not expecting, by the terminal, that a preset limitation condition is met through performing a DCI alignment between MC-DCI of different formats in any one cell; or
in a case where one or more pieces of MC-DCI are configured for any one cell, not expecting, by the terminal, that sizes of the MC-DCI are changed in an alignment manner.

8. The method of claim 1, further comprising:
when there are first cells scheduled simultaneously with different MC-DCI for the multiple cells, before determining the target size of the MC-DCI, determining that a DCI alignment is performed on the different MC-DCI in a zero-padding manner.

9. The method of claim 1, further comprising:
when there is a second cell configured with legacy DCI in the multiple cells, and a size of the legacy DCI before a DCI alignment is greater than the target size of the MC-DCI for the second cell, determining that the DCI alignment is performed on the legacy DCI and the MC-DCI of the target size in the second cell in a truncating manner; and
wherein the size of the legacy DCI configured for any one cell is not greater than the target size of the MC-DCI.

10. (canceled)

11. A downlink control information (DCI) sending method, performed by a base station and comprising:
determining multiple cells scheduled by multi-cell downlink control information (MC-DCI);
determining a target size of the MC-DCI for the multiple cells; and
sending the MC-DCI to a terminal in a scheduling cell based on the target size of the MC-DCI.

12. The method of claim 11, wherein the determining a target size of the MC-DCI for the multiple cells, comprises:
determining, for at least one cell in the multiple cells, one or more first sizes of the MC-DCI; and
determining the target size of the MC-DCI based on the determined one or more first sizes of the MC-DCI for the at least one cell in the multiple cells.

13. The method of claim 12, wherein the determining, for at least one cell in the multiple cells, one or more first sizes of the MC-DCI, comprises:
performing a DCI alignment on DCI comprising the MC-DCI for the at least one cell, such that a number of sizes of DCI configured for each of the multiple cells meets a preset limitation condition; and
determining the one or more first sizes of the MC-DCI for the at least one cell.

14. (canceled)

15. The method of claim 12, wherein the determining the target size of the MC-DCI based on the determined one or more first sizes of the MC-DCI for the at least one cell in the multiple cells, comprises:
taking a maximum value of the determined one or more first sizes of the MC-DCI for the at least one cell as the target size of the MC-DCI.

16. The method of claim 12, further comprising:
when the determined first sizes are different, performing a DCI alignment on the MC-DCI of the first sizes to the MC-DCI of the target size in a zero-padding manner.

17. (canceled)

18. The method of claim 11, further comprising:
when there are first cells scheduled simultaneously with different MC-DCI for the multiple cells, before determining the target size of the MC-DCI, performing a DCI alignment on the different MC-DCI in a zero-padding manner.

19. The method of claim 11, further comprising:
when there is a second cell configured with legacy DCI in the multiple cells, and a size of the legacy DCI is greater than the target size of the MC-DCI for the second cell, performing a DCI alignment on the legacy DCI and the MC-DCI of the target size in the second cell in a truncating manner;
wherein the method further comprises:
not configuring, by the base station, legacy DCI with a size greater than the target size in any one cell.

20.-22. (canceled)

23. A non-transitory computer readable storage medium storing a computer program that, when executed by a processor, causes the processor
determine multiple cells scheduled by multi-cell downlink control information (MC-DCI);
determine a target size of the MC-DCI for the multiple cells; and
receive and parse the MC-DCI in a scheduling cell based on the target size of the MC-DCI.

24. A non-transitory computer readable storage medium storing a computer program that, when executed by a processor, causes the processor to perform the DCI sending method of claim 11.

25. A downlink control information (DCI) receiving apparatus, comprising:
a processor; and
a memory configured to store instructions executable by the processor;
wherein the processor is configured to perform the DCI receiving method of claim 1.

26. A downlink control information (DCI) sending apparatus, comprising:
a processor; and
a memory configured to store instructions executable by the processor;
wherein the processor is configured to perform the DCI sending method of claim 11.
